(19) United States
(12) Patent Application Publication
(10) Pub. No.: US 2019/0056907 A1
(43) Pub. Date: Feb. 21, 2019

(54) ELECTRONIC DEVICE, SOUND OUTPUT SYSTEM AND ELECTRONIC DEVICE CONTROL METHOD FOR SOUND OUTPUT SYSTEM

(71) Applicant: Samsung Electronics Co., Ltd., Suwon-si, Gyeonggi-do (KR)

(72) Inventors: Yong-jin SO, Seoul (KR); Chang-hoon PARK, Seoul (KR); Won-hee LEE, Seoul (KR)

(73) Assignee: Samsung Electronics Co., Ltd., Suwon-si, Gyeonggi-do (KR)

(21) Appl. No.: 16/078,911

(22) PCT Filed: Dec. 8, 2016
(86) PCT No.: PCT/KR2016/014348

§ 371 Date: Aug. 22, 2018

(30) Foreign Application Priority Data
Feb. 25, 2016 (KR) 10-2016-0022831

(51) Int. Cl. G06F 3/16; H04W 8/00; G06F 3/01

(52) U.S. Cl. CPC G06F 3/167; H04W 8/00; G06F 3/162; G06F 3/01; G06F 3/165

(57) ABSTRACT

Provided is an electronic device including a communication interface configured to communicate with a plurality of sound output devices, a display, and a processor electrically connected to the communication interface and the display. The processor is configured to search for the plurality of sound output devices by using the communication interface, to display on the display a plurality of identification regions representing the plurality of sound output devices, and an information region representing information about a sound output device corresponding to at least one of the plurality of identification regions, and to set the plurality of sound output devices to operate with one another based on a signal for moving at least one of the plurality of identification regions.

### TECHNICAL FIELD

The present disclosure relates to an electronic device, a sound output system, and a method of controlling an external speaker, and more particularly, to an electronic device capable of simultaneously adjusting a plurality of external speaker devices that a user desires, a sound output system, and a method of controlling an external speaker.

### BACKGROUND ART

As industry has recently become more sophisticated, all kinds of electronic devices are being digitized, and digitization is also rapidly spreading in acoustic devices, there is demand for sound quality to be improved.

In detail, a sound output device according to the related art is only capable of reproducing a sound source provided by wire, but a sound output device has been recently connected to an access point (AP) in a wireless manner to output sound source content stored in a cloud server. Moreover, such a sound output device may be individually arranged in a plurality of spaces to output content that is the same as or different from one another.

In the above environment, a user has to individually adjust each sound output device in order to reproduce a sound source from a plurality of sound output devices, and thus, the user may experience inconvenience.

### DESCRIPTION OF EMBODIMENTS

### Technical Problem

Provided are a user electronic device capable of simultaneously adjusting a plurality of external sound output devices desired by a user, a sound output system, and a method of controlling a sound output device.

### BRIEF DESCRIPTION OF DRAWINGS

FIG. 1 is a block diagram of a sound output system according to an embodiment of the present disclosure.

FIG. 2 is a diagram of a network environment according to an embodiment of the present disclosure.

FIG. 3 is a schematic block diagram of an electronic device and a sound output device, according to an embodiment of the present disclosure.

FIG. 4A is a flowchart illustrating a method of controlling a sound output system, according to an embodiment of the present disclosure.

FIG. 4B is a diagram for describing a situation in which a plurality of sound output devices 110 operate in linkage with one another.

FIG. 5 is a flowchart illustrating that an electronic device receives information from a sound output device that is found and displays the information as a graphic user interface (GUI) in a sound output system, according to an embodiment of the present disclosure.

FIGS. 6A to 6C are diagrams of a screen displaying a GUI for controlling sound output devices in an electronic device, according to an embodiment of the present disclosure.

FIG. 7 is a flowchart for describing that an electronic device, according to an embodiment of the present disclosure, controls a plurality of sound output devices simultaneously by moving a plurality of identification regions.

FIGS. 8A and 8B are diagrams of a screen for simultaneously controlling a plurality of sound output devices by moving a plurality of identification regions in an electronic device, according to an embodiment of the present disclosure.

FIG. 9 is a flowchart for describing that an electronic device, according to an embodiment of the present disclosure, individually controls sound output devices by separately moving an identification region.

FIGS. 10A and 10B are diagrams of a screen for individually controlling sound output devices by separately moving an identification region in an electronic device, according to an embodiment of the present disclosure.

FIGS. 11A to 11C are diagrams showing a situation in which sound source content is moved in an electronic device, according to an embodiment of the present disclosure.

FIG. 12 is a diagram showing an electronic device displaying sound source content, according to an embodiment of the present disclosure.

FIGS. 13A and 13B are diagrams for describing switching of an order of identification regions in an electronic device, according to an embodiment of the present disclosure.

FIG. 14 is a block diagram of an electronic device 1401 according to various embodiments.

FIG. 15 is a block diagram of a program module according to various embodiments.

### BEST MODE

An electronic device according to an embodiment includes a communication interface communicating with a plurality of sound output devices, a display, and a processor electrically connected to the display. The processor searches for the plurality of sound output devices by using the communication interface, and represents on the display a plurality of identification regions expressing the plurality of sound output devices and an information region representing information about a sound output device corresponding to at least one of the plurality of identification regions. In addition, the processor may set the plurality of sound output devices to operate together with one another, based on a signal for moving the at least one of the plurality of identification regions.

A sound output system according to an embodiment may include a plurality of sound output devices, and an electronic device configured to search for the plurality of sound output devices by using a communication interface, to display a plurality of identification regions representing the plurality of sound output devices and an information region representing information about a sound output device corresponding to at least one of the plurality of information regions, and to set the plurality of sound output devices to operate together based on a signal for moving at least one of the plurality of identification regions.

A method of controlling an electronic device controlling a plurality of sound output devices, according to an embodiment, may include searching for the plurality of sound output devices connected to a network, displaying a plurality of identification regions representing the plurality of sound output devices that are found and an information region representing information regarding a sound output device corresponding to at least one of the plurality of identification regions, and setting the plurality of sound output devices to operate with one another based on a signal for moving at least one of the plurality of identification regions.

### MODE OF DISCLOSURE

Hereinafter, one or more embodiments of the present disclosure will be described below with reference to accompanying drawings. However, the techniques disclosed in the present disclosure are not limited to a certain embodiment, but should be appreciated to include various modifications, equivalents, and/or alternatives of the embodiments. Regarding the description of the drawings, like reference numerals may be used for like components.

It will be further understood that the terms “comprise” and/or “have,” when used in this specification, specify the presence of stated features, integers, steps, operations, elements, and/or components, but do not preclude the presence or addition of one or more other features, integers, steps, operations, elements, components, and/or groups thereof.

As used herein, the term “A or B”, “at least one of A and/or B”, or “one or more of A and/or B” includes any and all combinations of one or more of the associated listed items. For examples, “A or B”, “at least one of A and B”, “at least one of A or B” each may include (1) at least one A, or include (2) at least one B, or include (3) both at least one A and at least one B.

Ordinal numbers as herein used, such as “first”, “second”, etc., may modify various components of various embodiments, but do not limit those components. For example, these terms do not limit the order and/or importance of the components. These terms are only used to distinguish one component from another. For example, a first user device and a second user device are different user devices from each other. For example, according to various embodiments of the present disclosure, a first component may be denoted a second component, and vice versa without departing from the scope of the present disclosure.

When a component (e.g., a first component) is “(operatively or communicatively) connected to or coupled to” another component (a second component), the component may be directly connected or coupled to the other component, or other component(s) (e.g., a third component) may intervene therebetween. In contrast, when a component (e.g., a first component) is directly “connected to” or “directly coupled to” another component (e.g., a second component), no other intervening components (e.g., a third component) may intervene therebetween.

The expression “configured to” used in the present disclosure may be exchanged with, for example, “suitable for”, “having the capacity to”, “designed to”, “adapted to”, “made to”, or “capable of” according to the situation. The term “configured to” may not necessarily imply “specifically designed to” in hardware. Alternatively, in some situations, the expression “device configured to” may mean that the device, together with other devices or components, “is able to”. For example, the phrase “processor adapted (or configured) to perform A, B, and C” may mean a dedicated processor (e.g. embedded processor) only for performing the corresponding operations or a generic-purpose processor (e.g., central processing unit (CPU) or application processor (AP)) that can perform the corresponding operations by executing one or more software programs stored in a memory device.

The terms as used in various embodiments of the present disclosure are merely for the purpose of describing particular embodiments and are not intended to limit the present disclosure to the various embodiments. As used herein, the singular forms are intended to include the plural forms as well, unless the context clearly indicates otherwise. Unless defined otherwise, all terms used herein, including technical terms and scientific terms, have the same meaning as commonly understood by a person of ordinary skill in the art to which various embodiments of the present disclosure pertain. Such terms as those defined in a generally used dictionary are to be interpreted to have the meanings equal to the contextual meanings in the relevant field of art, and are not to be interpreted to have ideal or excessively formal meanings unless clearly defined in the present disclosure. In some cases, even the term defined in the disclosure should not be interpreted to exclude embodiments of the disclosure.

An electronic device according to various example embodiments of the disclosure may include at least one of, for example, a smart phone, a tablet personal computer (PC), a mobile phone, a video phone, an electronic book reader (e-book reader), a desktop PC, a laptop PC, a netbook computer, a workstation, a server, a Personal Digital Assistant (PDA), a Portable Multimedia Player (PMP), a MPEG-1 audio layer-3 (MP3) player, a mobile medical device, a camera, and a wearable device. According to various example embodiments, the wearable device may include, for example, at least one of an accessory type (e.g., a watch, a ring, a bracelet, an anklet, a necklace, a glasses, a contact lens, or a head-mounted device (HMD)), a fabric or clothing integrated type (e.g., electronic clothing), a body-mounted type (e.g., a skin pad, or tattoo), and a bio-implantable type (e.g., an implantable circuit), or the like.

According to some example embodiments, the electronic device may, for example, be a home appliance. The home appliance may include at least one of, for example, a television, a Digital Video Disk (DVD) player, an audio, a refrigerator, an air conditioner, a vacuum cleaner, an oven, a microwave oven, a washing machine, an air cleaner, a set-top box, a home automation control panel, a security control panel, a TV box (e.g., Samsung HomeSync™, AppleTV™, or Google TV™), a game console (e.g., Xbox™ and PlayStation™), an electronic dictionary, an electronic key, a camcorder, and an electronic photo frame.

According to another example embodiment, the electronic device may include, for example, at least one of various medical devices (e.g., various portable medical measuring devices (a blood glucose monitoring device, a heart rate monitoring device, a blood pressure measuring device, a body temperature measuring device, etc.), a magnetic resonance angiography (MRA), a magnetic resonance imaging (MRI), a computed tomography (CT) machine, and an ultrasonic machine), a navigation device, a global positioning system (GPS) receiver, an event data recorder (EDR), a flight data recorder (FDR), a vehicle infotainment devices, an electronic devices for a ship (e.g., a navigation device for a ship, and a gyro-compass), avionics, security devices, an automotive head unit, a robot for home or industry, an automatic teller's machine (ATM) in banks, point of sales (POS) in a shop, or internet device of things (e.g., a light bulb, various sensors, electric or gas meter, a sprinkler device, a fire alarm, a thermostat, a streetlamp, a toaster, a sporting goods, a hot water tank, a heater, a boiler, etc.).

According to some example embodiments, the electronic device may include, for example, at least one of a part of furniture or a building/structure, an electronic board, an electronic signature receiving device, a projector, and various kinds of measuring instruments (e.g., a water meter, an electric meter, a gas meter, and a radio wave meter). The electronic device according to various example embodiments of the disclosure may, for example, be a combination of one or more of the aforementioned various devices. The electronic device according to some example embodiments of the disclosure may be a flexible device, or the like. Further, the electronic device according to an example embodiment of the disclosure is not limited to the aforementioned devices, and may include a new electronic device according to the development of technology.

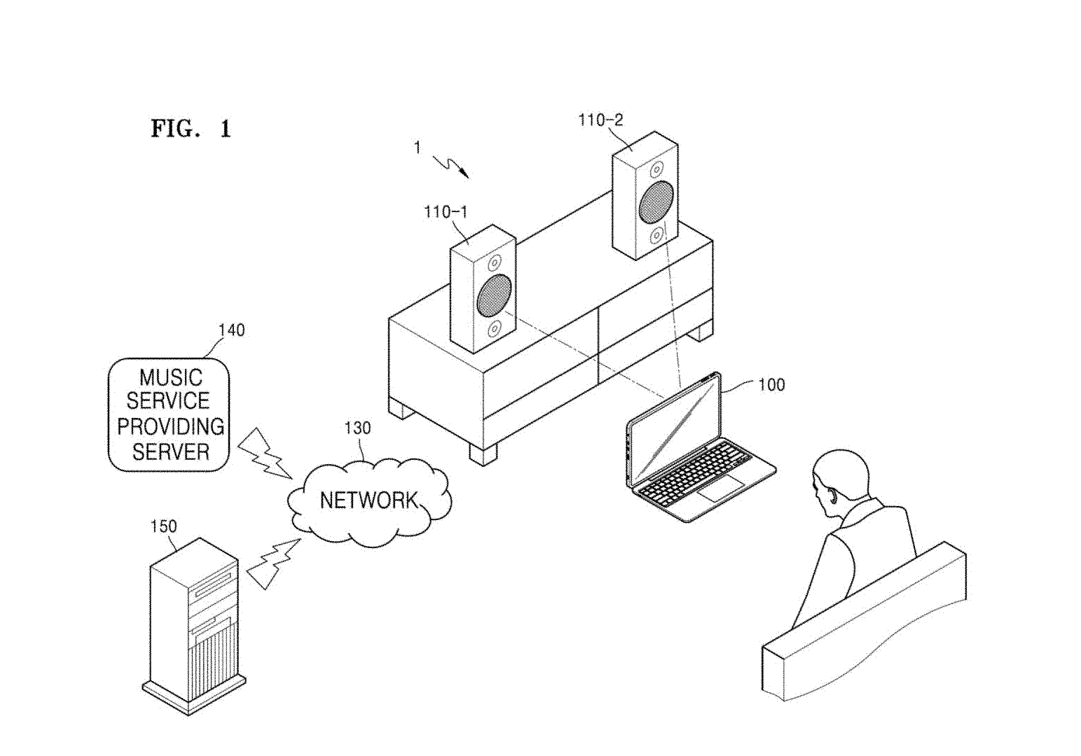

FIG. 1 is a block diagram of a sound output system according to an embodiment of the present disclosure.

Referring to FIG. 1, in a sound output system 1 according to an embodiment, an electronic device 100, a plurality of sound output devices 110 including a first sound output device 110-1 and a second sound output device 110-2, a music service providing server 140, and an external electronic device 150 may be connected to one another via a network 130 by which they may communicate with one another.

In the sound output system 1 according to the embodiment, the electronic device 100 controls the plurality of sound output devices 110 so that the plurality of sound output devices 110 may output sound source content stored in at least one of an external server (not shown), the external electronic device 150, the music service providing server 140, and the electronic device 100.

Each of the plurality of sound output devices 110 may be connected to the external server (not shown), the external electronic device 150, or the music service providing server 140 via the network 130, and may receive and output the sound source content from the external server (not shown), the external electronic device 150, or the music service providing server 140.

For example, play list information may be registered in advance or address information for receiving the sound source content may be registered in advance in the plurality of sound output devices 110. Therefore, each of the plurality of sound output devices 110 may receive and output the sound source content from the external electronic device 150 or the music service providing server 140 based on the registered play list information or the address information. The address information or the play list information stored in the sound output devices 110 may be equal to or different from one another.

The plurality of sound output devices 110 may output the sound source content stored in the external electronic device 150 or the music service providing server 140 in a streaming manner. Also, the plurality of sound output devices 110 may download the sound source content from the external electronic device 150 or the music service providing server 140 and temporarily store the sound source content, and then, may output the sound source content that is temporarily stored.

Each of the plurality of sound output devices 110 may provide the electronic device 100 with device information of its own through the network 130. The device information may include, for example, information about names, sound source content, current volume, addresses, connected service, connected external electronic devices, etc. of the sound output devices 110.

The electronic device 100 is connected to the network 130, and may search for the sound output devices 110 connected to the network 130. The electronic device 100 may display information about the sound output devices 110 that are found as one graphic user interface (GUI).

The GUI about the sound output devices 110 may include, for example, an identification region representing each of the sound output devices 110, an information region representing device information of each of the sound output devices 110, and a control region for performing playing, stopping, and volume adjusting of content included in the sound output devices 110. However, the present disclosure is not limited thereto, that is, the GUI about the sound output devices 110 may be implemented in various types and may further include various pieces of information. For example, the GUI for controlling the sound output devices 110 may represent, from among the sound output devices 110 connected to the electronic device 100 via the network 130, the sound output devices that may not be displayed on a display of the electronic device 100 due to a limitation in a display size of the electronic device 100 as icons, taps, etc. on a separate area.

Referring to FIG. 1, two sound output devices 110 are arranged in the sound output system 1, but the sound output system 1 according to the embodiment may include three or more sound output devices. Also, the sound output devices 110 are shown to be arranged in one space, but the sound output system 1 may include the sound output devices that are arranged in separate spaces that are partitioned by a wall. For example, the sound output devices 110 may be respectively arranged in a plurality of rooms in a house.

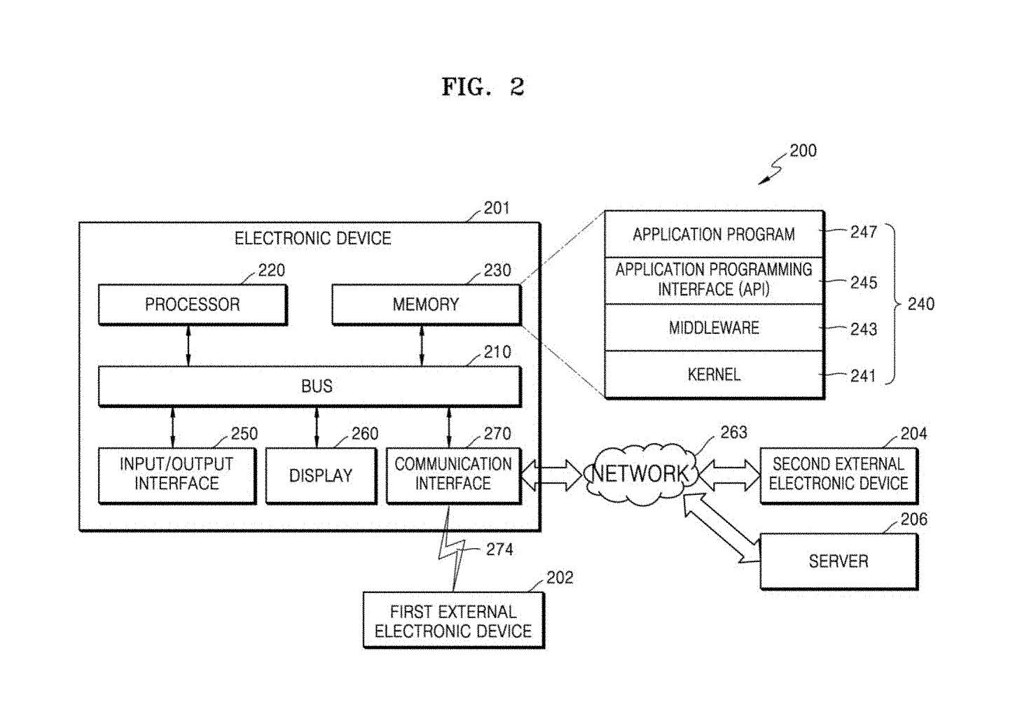

FIG. 2 is a diagram of a network environment according to an embodiment of the present disclosure.

An electronic device 201 in a network environment 200 according to various embodiments will be described below with reference to FIG. 2. The network environment 200 of FIG. 2 may include the sound output system 1 of FIG. 1. The electronic device 201 of FIG. 2 may include the electronic device 100 of FIG. 1.

The electronic device 201 may include a bus 210, a processor 220, a memory 230, an input/output interface 250, a display 260, and a communication interface 270. In some embodiments, the electronic device 201 may omit at least one of the components, or may further include an additional component.

The bus 210 may include, for example, a circuit connecting the components (210 to 270) to one another and transmitting communication (e.g., a control message and/or data) among the components.

The processor 220 may include at least one of a central processing unit (CPU), an application processor (AP), and a communication processor (CP). The processor 220 may execute, for example, calculations or data processing about controlling and/or communicating among at least one another component in the electronic device 201.

The memory 230 may include a volatile and/or non-volatile memory. The memory 230 may store, for example, commands or data regarding at least one another component in the electronic device 201. According to one embodiment, the memory 230 may store software and/or a program 240. The program 240 may include, for example, a kernel 241, middleware 243, an application programming interface (API) 245, and/or an application program (or “application”) 247, etc. At least some of the kernel 241, the middleware 243, or the API 245 may be referred to as an operating system (OS).

The kernel 241 may control or manage system resources (e.g., the bus 210, the processor 220, the memory 230, etc.) used to execute operations or functions implemented in other programs (e.g., the middleware 243, the API 245, or the application program 247). Also, the kernel 241 may provide an interface capable of controlling or managing the system resources, by accessing individual component of the electronic device 201 from the middleware 243, the API 245, or the application program 247.

The middleware 243 may perform mediation function so that, for example, the API 245 or the application program 247 may communicate with the kernel 241 and exchange data.

In addition, the middleware 243 may process one or more operation requests transmitted from the application program 247 according to a priority order. For example, the middleware 143 may grant to at least one of the application program 247 a priority order of using the system resources (e.g., the bus 210, the processor 220, or the memory 230) of the electronic device 201. For example, the middleware 243 processes the one or more operation requests according to the priority order granted to the at least one application program 247, thereby performing scheduling or load balancing of the one or more operation requests.

The API 245 is, for example, an interface for the application 247 to control the functions provided by the kernel 241 or the middleware 243, and may include at least one interface or function (e.g., instructions), for example, for file control, window control, image processing, or text control.

The input/output interface 250 may function as, for example, an interface capable of transmitting command or data input from the user or another external device to the other component(s) of the electronic device 201. In addition, the input/output interface 250 may output command or data transmitted from the other component(s) of the electronic device 201 to the user or another external device.

The display 260 may include, for example, a liquid crystal display (LCD), a light-emitting diode (LED) display, an organic light-emitting diode (OLED) display, a microelectromechanical systems (MEMS) display, or an electronic paper display. The display 260 may display, for example, various pieces of content (e.g., text, images, videos, icons, or symbols) to the user. The display 260 may include a touch screen, and may receive, for example, a touch input, a gesture input, a proximity input, or a hovering input via an electronic pen or a part of a body of the user.

The communication interface 270 may set communications between, for example, the electronic device 201 and an external device (e.g., a first external electronic device 202, a second external electronic device 204, or a server 206). For example, the communication interface 270 is connected to a network 263 via wireless communication or wires communication to communicate with an external device (e.g., the second external electronic device 204 or the server 206).

The wireless communication may use a cellular communication protocol, for example, at least one of long-term evolution (LTE), LTE-advance (LTE-A), code division multiple access (CDMA), wideband CDMA (WCDMA), universal mobile telecommunications system (UMTS), wireless broadband (WiBro), and global system for mobile communications (GSM). Also, the wireless communication may include, for example, near distance communication 274. The near distance communication 274 may include, for example, at least one of wireless fidelity (WiFi), Bluetooth, near field communication (NFC), and global navigation satellite system (GNSS). GNSS may include, for example, at least one of global positioning system (GPS), global navigation satellite system (Glonass), Beidou navigation satellite system (Beidou) or Galileo, and the European global satellite-based navigation system, according to used region or bandwidth. Hereinafter, in the present specification, GPS and GNSS may be interchangeably used. The wires communication may include, for example, at least one of universal serial bus (USB), high definition multimedia interface (HDMI), recommended standard-232 (RS-232), and plain old telephone service (POTS). The network 263 may include telecommunications network, for example, at least one of computer network (e.g., LAN or WAN), Internet, and telephone network.

The first and second external electronic devices 202 and 204 may each be a device of the same kind as or different from the electronic device 201. According to one embodiment, the server 206 may include a group of one or more servers. According to various embodiments, all or some of operations performed in the electronic device 201 may be executed in one or more other electronic devices (e.g., the electronic devices 202 and 204), or the server 206. According to one embodiment, in a case where the electronic device 201 has to perform a certain function or service automatically or upon request, the electronic device 201 may request another device (e.g., the electronic devices 202 and 204, or the server 206) to perform at least some functions related to the certain function or service, instead of or additionally to the executing of the certain function or service on its own. The electronic device (e.g., the electronic device 202 and 204, or the server 206) may execute requested function or the additional function, and may transfer a result of execution to the electronic device 201. The electronic device 201 may provide requested function or service after processing or without processing the result. To do this, for example, a cloud computing, a distributed computing, or a client-server computing technique.

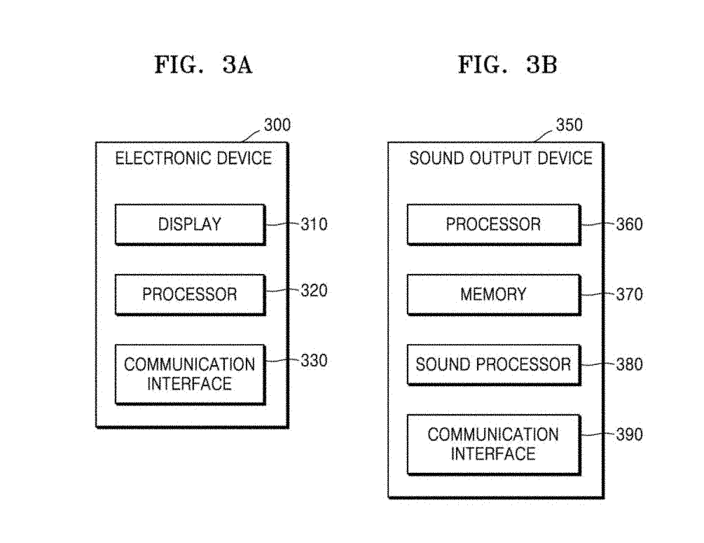

FIG. 3 is a schematic block diagram of an electronic device and a sound output device according to an embodiment of the present disclosure.

Referring to (a) of FIG. 3, an electronic device 300 according to an embodiment may include a display 310, a processor 320, and a communication interface 330. The elements shown in (a) of FIG. 3 in the electronic device 300 according to the embodiment are not essential, that is, the electronic device 300 may have more or less elements than those of FIG. 3 (a). For example, the electronic device 300 may include an input module (e.g., a touch panel, a physical key, a proximity sensor, a bio-sensor, etc.), an analog/digital (ND) converter, a power supplier, etc.

The electronic device 300 may search for the sound output devices 110 connected to the network 130 by using the communication interface 330. The communication interface 330 may include the communication interface 270 shown in FIG. 2. Therefore, the communication methods such as the wireless communication, near field communication, etc. described above with reference to FIG. 2 may be used.

The display 310 may display a GUI for controlling found sound output devices 110 on a screen. The display 310 may be implemented as a touch screen including a touch panel. Therefore, a user may use the GUI for controlling the sound output devices by touching or dragging the GUI displayed on the screen.

The processor 320 may basically control the elements included in the electronic device 300. For example, the processor 320 may search for the sound output devices 110 by using the communication interface 330, or may generate the GUI configuration for controlling the sound output devices 110 that are found and display the GUI on the display 310.

The processor 320 according to the embodiment may control the sound output devices 110 connected to the electronic device 300 in response to a user's signal for controlling the plurality of sound output devices 110 by using the GUI for controlling the sound output devices 110. The processor 320 may integrate or separate the GUI for controlling the plurality of sound output devices 110, for example, based on an input signal of the user, in order to guide the user to easily control the plurality of sound output devices 110.

Referring to (b) of FIG. 3, a sound output device 350 according to an embodiment may include a processor 360, a memory 370, a sound processor 380, and a communication interface 390. However, the present disclosure is not limited thereto, that is, the sound output device 350 may further include a plurality of elements for performing a function of outputting sound. The sound output device 350 may include the sound output devices 110-1 and 110-2 of FIG. 1.

The sound output device 350 may communicate with the electronic device 300 or other sound output devices connected to the network 130 by using the communication interface 390 in the sound output device 350. Also, the sound output device 350 may download sound source content from the music service providing server 140 or the external electronic device 150 connected to the network 130 by using the communication interface 390 of the sound output device 350. The communication interface 390 of the sound output device 350 may include the communication interface 270 of FIG. 2. Therefore, the communication methods such as the wireless communication, near field communication, etc. described above with reference to FIG. 2 may be used.

The processor 360 of the sound output device 350 may read and use various software programs stored in the memory 370 of the sound output device 350. The memory 370 of the sound output device 350 may store sound source content on its own, or may download and temporarily store the sound source content from the music service providing server 140 or the external electronic device 150. The memory 370 of the sound output device 350 may store the GUI that has been used or address of the music service providing server 140 or the external electronic device 150 that has been connected, by communicating with the music service providing server 140 or the external electronic device 150, and then, may transmit the GUI or the address to the electronic device 300.

The sound processor 380 may include a module or a circuit for outputting sound. For example, the sound processor 380 may include a converter for converting a digital signal received through the communication interface 390 of the sound output device 350 into an analog sound source content signal. The sound processor 380 may include an amplification circuit for amplifying the analog sound signal. Also, the sound processor 380 may convert the analog sound source content stored in the memory 370 of the sound output device 350 into a digital signal to share the digital signal with other sound output devices.

The processor 360 of the sound output device 350 may basically control the elements included in the sound output device 350. For example, the processor 360 of the sound output device 350 may store the sound source content received through the communication interface 390 of the sound output device 350 in the memory 370, perform a post-process on the stored sound source content by using the sound processor 380, and then, output the sound source content.

The electronic device according to the embodiment includes a communication interface communicating with a plurality of sound output devices, a display, and a processor electrically connected to the display. The processor searches for the plurality of sound output devices by using the communication interface, and represents on the display a plurality of identification regions expressing the plurality of sound output devices and an information region representing information about a sound output device corresponding to at least one of the plurality of identification regions. In addition, the processor may set the plurality of sound output devices to operate together with one another, based on a signal for moving the at least one of the plurality of identification regions.

In the electronic device according to the embodiment, the information region may represent at least one of a list of content output through the sound output device, and information about the external electronic device connected to the sound output device or a content providing service.

In the electronic device according to the embodiment, the processor may group a first identification region and a second identification region to be represented as a third identification region based on a signal for moving the first identification region to overlap with the second identification region, from among the plurality of identification regions, and may control a sound output device corresponding to the first identification region and a sound output device corresponding to the second identification region together.

In the electronic device according to the embodiment, when the first identification region is moved to overlap with the second identification region from among the plurality of identification regions, the processor may set content included in a first information region corresponding to the first identification region and content included in a second information region corresponding to the second identification region to be included in a third information region corresponding to the third identification region.

In the electronic device according to the embodiment, when the first identification region is moved to overlap with the second identification region from among the plurality of identification regions, the processor may set the sound source content output through the sound output device corresponding to the second identification region to be also output through the sound output device corresponding to the first identification region.

In the electronic device according to the embodiment, when the first identification region is moved to overlap with the second identification region from among the plurality of identification regions, the processor may set the outputting of the sound source content from the sound output device corresponding to the first identification region to be stopped and the sound source content output from the sound output device corresponding to the second identification region to be also output from the sound output device corresponding to the first identification region.

In the electronic device according to the embodiment, the processor may ungroup the first identification region and the second identification region based on a signal for separating the first identification region and the second identification region from the grouped third identification region, and may individually control the sound output device corresponding to the first identification region and the sound output device corresponding to the second identification region.

In the electronic device according to the embodiment, when the first identification region and the second identification region is ungrouped, the processor may set the content included in the third information region corresponding to the third identification region to be separately represented in the first information region corresponding to the first identification region and the second information region corresponding to the second identification region.

In the electronic device according to the embodiment, when the first identification region and the second identification region are ungrouped, the processor may maintain the outputting of the sound source content from the sound output device corresponding to the first identification region and stop outputting the sound source content from the sound output device corresponding to the second identification region.

In the electronic device according to the embodiment, when the first identification region and the second identification region are ungrouped, the processor may stop outputting the sound source content from the sound output device corresponding to the first identification region and may display, on the first information region, information regarding at least one of another external electronic device or music service to which the sound output device corresponding to the first identification region has been connected before the grouping.

In the electronic device according to the embodiment, the processor, based on a signal for moving at least one of content list displayed in the first information region corresponding to the first identification region to overlap with the second identification region from among the plurality of identification regions, may set the content displayed in the first information region to be reproduced by the sound output device corresponding to the second identification region.

In the electronic device according to the embodiment, based on a signal for hovering over the second identification region or locating a selection icon on the second identification region in a state where the first identification region from among the plurality of identification regions, the first information region, and a first control region are displayed, the processor may display a list of sound source content reproduced by the sound output device corresponding to the second identification region.

The sound output system according to the embodiment may include a plurality of sound output devices, and an electronic device configured to search for the plurality of sound output devices by using a communication interface, to display a plurality of identification regions representing the plurality of sound output devices and an information region representing information about a sound output device corresponding to at least one of the plurality of information regions, and to set the plurality of sound output devices to operate together based on a signal for moving at least one of the plurality of identification regions.

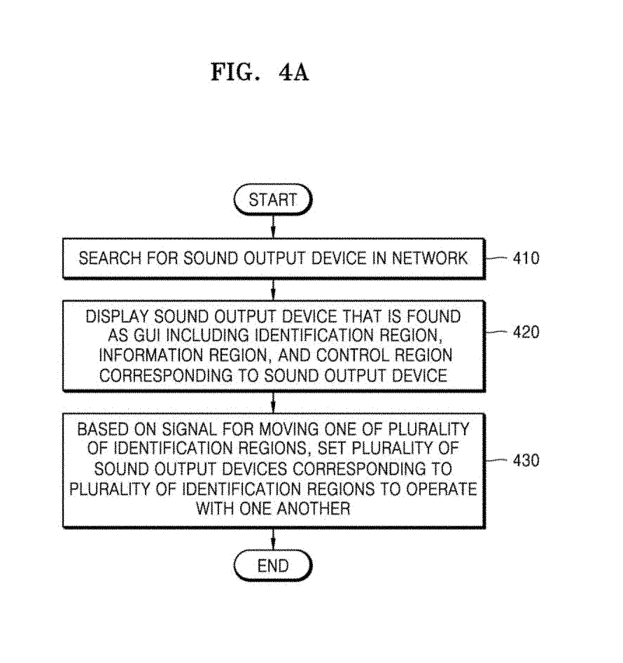

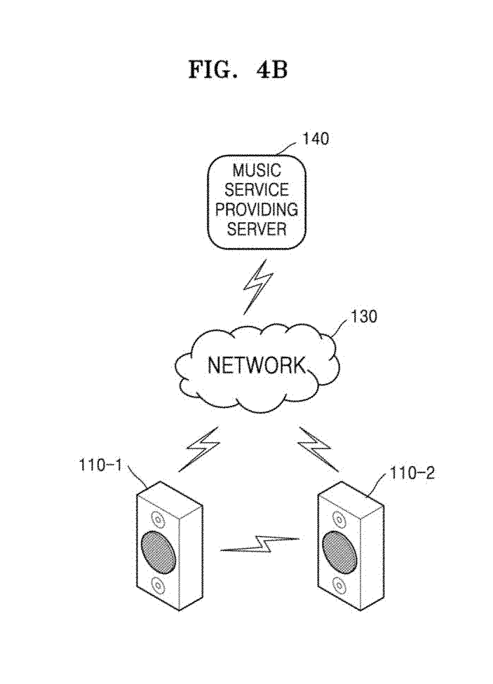

FIG. 4A is a flowchart illustrating a method of controlling a sound output system according to an embodiment of the present disclosure.

In operation 410, the electronic device 300 may search for sound output devices 110 in the network 130 by using the communication interface 330. For example, the electronic device 300 may be connected to the network 130 via wired or wireless communication to communicate with the sound output devices 110, as described above with reference to FIG. 2 or FIG. 3.

In operation 420, the electronic device 300 may display the sound output devices 110 that are found. The electronic device 300, for example, may display the sound output devices 110 as a GUI format.

The GUI may include a plurality of identification regions corresponding to the found sound output devices 110 and an information region representing information about a sound output device corresponding to at least one of the plurality of identification regions.

In operation 430, the electronic device 300 may set the plurality of sound output devices 110 corresponding to the plurality of identification regions to operate in linkage with one another, based on a signal for moving at least one of the plurality of identification regions.

FIG. 4B is a diagram for describing a situation in which a plurality of sound output devices operate in linkage with one another.

When receiving a signal for moving the plurality of identification regions to overlap with each other, the electronic device 300 may combine sound source content of the sound output devices 110 corresponding to the overlapping identification regions with each other. Also, when receiving a signal for moving the plurality of identification regions to overlap with each other, the electronic device 300 may set the first sound output device 110-1 to maintain the outputting of the sound source content and the second sound output device 110-2 to stop outputting the sound source content. Alternatively, the electronic device 300 may set the second sound output device 110-2 to output the sound source content output from the first sound output device 110-1, together with the first sound output device 110-1.

When the operation as above occurs, the electronic device 300 may set, for example, the second sound output device 110-2 to directly communicate with a music source (e.g., cloud server) connected to the first sound output device 110-1, or may set the second sound output device 110-2 to receive the sound source content of the first sound output device 110-1 via the first sound output device 110-1.

According to another embodiment, when each of the sound output devices 110-1 and 110-2 stores the sound source content, the electronic device 300 may set the sound source content stored in the first sound output device 110-1 to be moved and/or copied to the second sound output device 110-2.

The first sound output device 110-1 and the second sound output device 110-2 may communicate with each other via the network 130. Alternatively, the first sound output device 110-1 and the second sound output device 110-2 may communicate with each other or move and/or copy the sound source content via direct data communication (e.g., Wi-Fi Direct).

The electronic device 300 may set the plurality of sound output devices 110 corresponding to the plurality of identification regions to individually operate, based on a signal for partitioning one identification region into a plurality of pieces.

For example, when receiving a signal for partitioning one identification region into a plurality of pieces, the electronic device 300 may set the first sound output device 110-1 to maintain the outputting of the sound source content and the second sound output device 110-2 to stop outputting the sound source content, between the plurality of sound output devices 110-1 and 110-2 corresponding to the partitioned identification regions.

Hereinafter, operations in the method of controlling the sound output system will be described below in more detail.

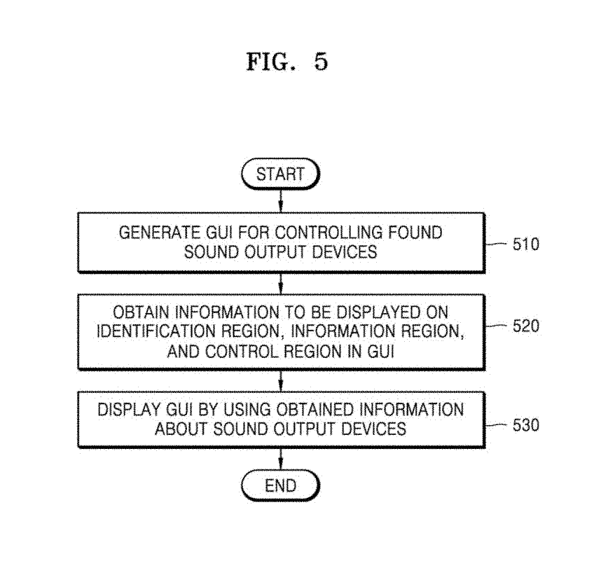

FIG. 5 is a flowchart illustrating that an electronic device receives information from a found sound output device and displays the information as a GUI in a sound output system according to an embodiment of the present disclosure.

In operation 510, the electronic device 300 may generate a GUI for controlling sound output devices 110 that are found. The GUI for controlling the sound output devices 110 may include three regions (e.g., an identification region, an information region, and a control region).

The identification region may represent, for example, the sound output devices 110. That is, one identification region may represent one sound output device. The information region may represent, for example, information regarding the sound output devices 110 that are found. The information regarding the sound output devices 110 may include, for example, name information of the sound output devices 110, sound source content information, current volume information, address information, connected service information, information about connected external electronic device, etc. The control region may be, for example, a region for playing or stopping the sound source content, or for adjusting volume.

In operation 520, the electronic device 300 may obtain information to be displayed in the identification region, the information region, and the control region, from the sound output devices 110 that are found.

In operation 530, the electronic device 300 may display a GUI for controlling the sound output devices 110 by using the obtained information of the sound output devices 110. For example, the electronic device 300 may fill content in the identification regions by using the name information, the address information, etc. of the sound output devices 110. In addition, the electronic device 300 may fill content in the information region by using the sound source content included in the sound output devices 110 or information of the music service providing server 140 or the external electronic device 150 that is communicating with the sound output devices 110.

The sound output system according to the embodiment may include a plurality of sound output devices, and an electronic device configured to search for the plurality of sound output devices by using a communication interface, to display a plurality of identification regions representing the plurality of sound output devices and an information region representing information about a sound output device corresponding to at least one of the plurality of information regions, and to set the plurality of sound output devices to operate together based on a signal for moving at least one of the plurality of identification regions.

A method of controlling an electronic device controlling a plurality of sound output devices, according to an embodiment, may include searching for the plurality of sound output devices connected to a network, displaying a plurality of identification regions representing the plurality of sound output devices that are found and an information region representing information regarding a sound output device corresponding to at least one of the plurality of identification regions, and setting the plurality of sound output devices to operate with one another based on a signal for moving at least one of the plurality of identification regions.

According to the method of controlling the electronic device that controls a plurality of sound output devices, the signal for moving at least one of the plurality of identification regions may include a signal for moving a first identification region to overlap with a second identification region, from among the plurality of identification regions, the first identification region and the second identification region are grouped based on the signal to be represented as a third identification region, and a sound output device corresponding to the first identification region and a sound output device corresponding to the second identification region are controlled together.

The method of controlling the electronic device that controls the plurality of sound output devices according to the embodiment may further include, when the first identification region from among the plurality of identification regions is moved to overlap with the second identification region, setting content included in a first information region corresponding to the first identification region and content included in a second information region corresponding to the second identification region to be included in a third information region corresponding to the third identification region.

The method of controlling the electronic device that controls the plurality of sound output devices according to the embodiment may include ungrouping the first identification region and the second identification region based on a signal for separating the first identification region and the second identification region from the third identification region, and individually controlling the sound output device corresponding to the first identification region and the sound output device corresponding to the second identification region.

The method of controlling the electronic device that controls the plurality of sound output devices according to the embodiment may further include, when the first identification region and the second identification region are ungrouped, displaying the content included in the third information region corresponding to the third identification region separately in the first information region corresponding to the first identification region and in the second information region corresponding to the second identification region.

The information region may display at least one of a list of content output through the sound output devices and information about the external electronic device or the content providing service connected to the sound output devices, and the method of controlling the electronic device may include, based on a signal for moving at least one in the list of content displayed in the first information region corresponding to the first identification region to overlap with the second identification region, setting the content displayed in the first information region to be reproduced by the sound output device corresponding to the second identification region.

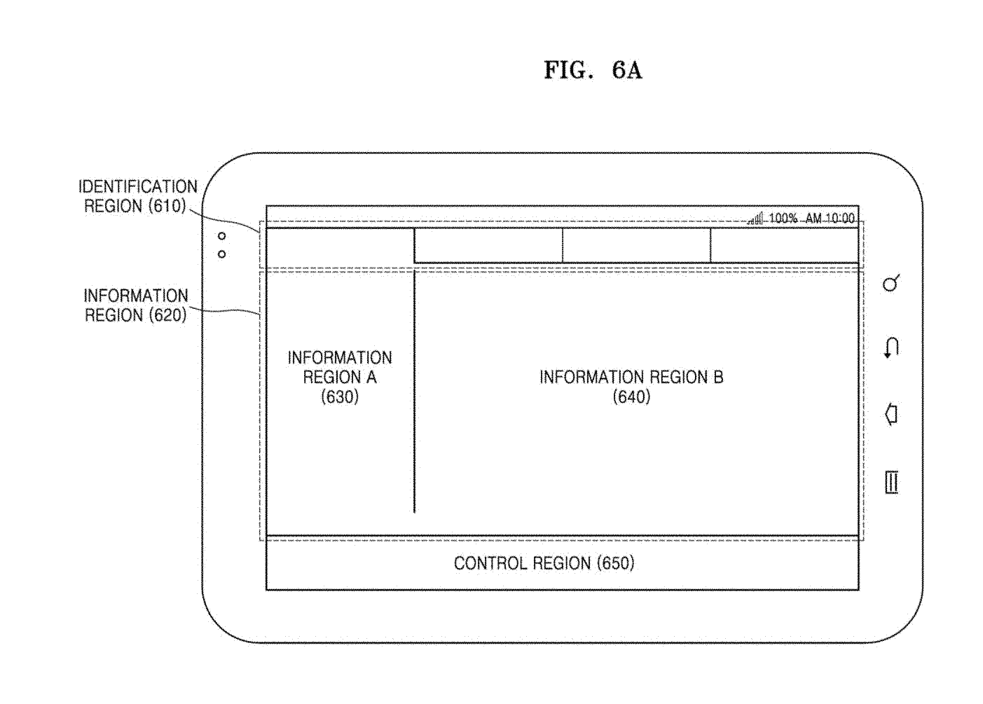

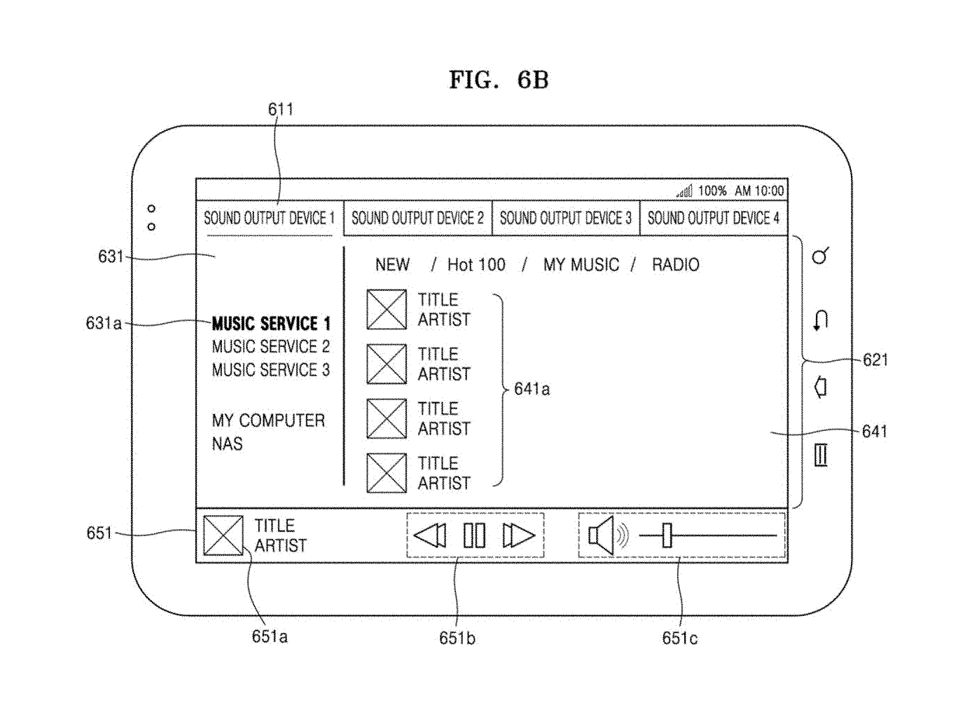

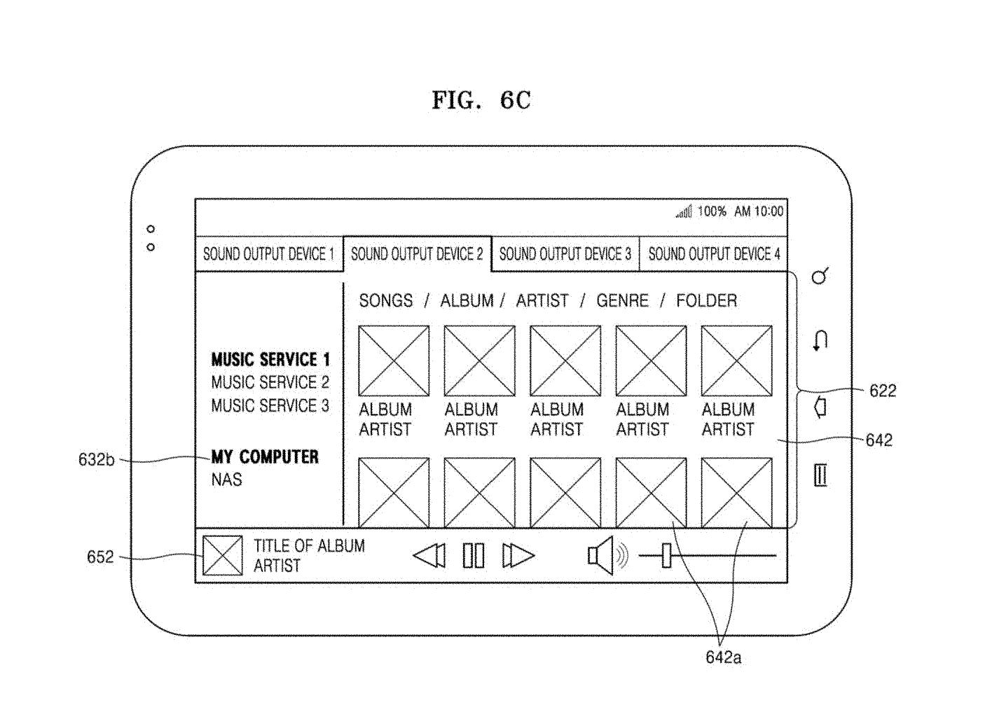

FIGS. 6A to 6C are diagrams of a screen displaying a GUI for controlling sound output devices in an electronic device according to an embodiment of the present disclosure.

Referring to FIG. 6A, the GUI for controlling the sound output devices may include three regions (e.g., an identification region 610, an information region 620, and a control region 650). However, the present disclosure is not limited thereto, and the GUI may further include elements for controlling the sound output devices 110 or controlling the sound output system 1.

The identification region 610 may represent the sound output devices 110 connected to the electronic device 300. In the identification region 610, for example, a plurality of tabs may be arranged. Also, in the present specification, moving of the identification region may denote moving of the tab included in the identification region. Referring to FIGS. 6B and 6C, a plurality of tabs 611 and 612 may each represent a sound output device corresponding thereto (e.g., the first sound output device 110-1 and the second sound output device 110-2).

The electronic device 300 may display information related to a sound output device selected by a user (e.g., the first sound output device 110-1 or the second sound output device 110-2) in the information region 620. When a first identification region 611 is selected, the information region 620 may correspond to a first information region 641, and when a second identification region 612 is selected, the information region 620 may correspond to a second information region 642. The information region 300 may partition, for example, the information region 620 into two regions (e.g., an information region A 630 and an information region B 640).

Also, the electronic device 300 may control the first sound output device 110-1 corresponding to the first identification region 611 by selecting the first identification region 611, and may control the second sound output device 110-2 corresponding to the second identification region 612 by selecting the second identification region 612.

The electronic device 300 may display, in the information region A 630, information related to the music service providing server 140 or the external electronic device 150 connected to the sound output devices 110, or information related to a cloud server. That is, the electronic device 300 may represent a source of the sound source content in the information region A 630. For example, the electronic device 300 may represent various sources where the sound source content comes from, e.g., “music service,” “my computer,” “network attached storage (NAS),” etc. in the information region A 630.

The electronic device 300 may represent a source of the sound source content, which is connected to the sound output device selected by the user, to be discriminated from the other sources. For example, the electronic device 300 may represent the source of the sound source content, which is connected to the first sound output device 110-1 selected by the user, in bold. However, the present disclosure is not limited thereto, and the electronic device 300 may express the connected source of the sound source content in different color from those of the other sources, or may only represent the source of sound source content, which is connected to the electronic device 300 or the first sound output device 110-1.

FIG. 6B shows an example, in which the first sound output device 110-1 is connected to a first music service 631a. The first music service 631a may be expressed in bold when compared with the other sources of sound source content. FIG. 6C shows an example, in which the second sound output device 110-2 is connected to my computer 632b. The source ‘my computer 632b’ may be expressed in bold when compared with the other sources of the sound source content.

Referring to FIG. 6A, the electronic device 300 may represent pieces of sound source content that may be reproduced in the information region B 640. A screen configuration of displaying the pieces of sound source content in the information region B 640 by the electronic device 300 may vary depending on the music source to which the sound output device is connected.

For example, FIG. 6B shows a screen in a case where the first sound output device 110-1 is connected to the first music service 631a. The electronic device 300 may display various groups of sound sources (e.g., new, hot 100, my music, radio, etc.) provided by the first music service 631a. In addition, the electronic device 300 may express pieces of reproducible content 641a included in the service selected by the user (e.g., new) as small icons.

FIG. 6C shows a screen in a case where the second sound output device 110-2 is connected to my computer 632b. The electronic device 300 may represent various groups of sound sources (e.g., songs, album, artist, genre, folder, etc.) classified by a music reproducing program in the ‘my computer’ 632b. In addition, the electronic device 300 may express pieces of reproducible content 642a included in the group selected by the user (e.g., album) as large icons.

Referring to FIG. 6A, the electronic device 300 may represent the sound source content that is currently playing, and a play icon, a stop icon, a volume adjustment icon, etc. in the control region 650. In more detail, referring to FIG. 6B, the electronic device 300 may represent sound source content 651a that is currently playing. The electronic device 300 may represent icons 651b for stopping the play of the currently playing sound source content 651a, or skipping to next or previous sound source content, and may represent an icon 651c for adjusting volume. When the first identification region 611 is selected, the control region 650 may be switched to the first control region 651, and when the second identification region 612 is selected, the control region 650 may be switched to the second control region 652.

However, the screen configuration is not limited to the above examples. For example, the electronic device 300 may differently configure the GUI for controlling the sound output devices according to the music sources to which the sound output devices 110 are connected. According to an embodiment, when the number of displayed sound output devices 110 is equal to or greater than a predetermined number, the electronic device 300 may configure the GUI for representing excessive sound output devices as separate icons and displaying as a pop-up only when the user selects the separate icon.

Although FIGS. 6A to 6C describes that the lists of sound source content are displayed in the information region 620 according to sources where the sound source content comes from, the present disclosure is not limited thereto. The list of sound sources to be reproduced by the sound output devices may be displayed on the information region 620, without being discriminated according to the sources providing the sound source content.

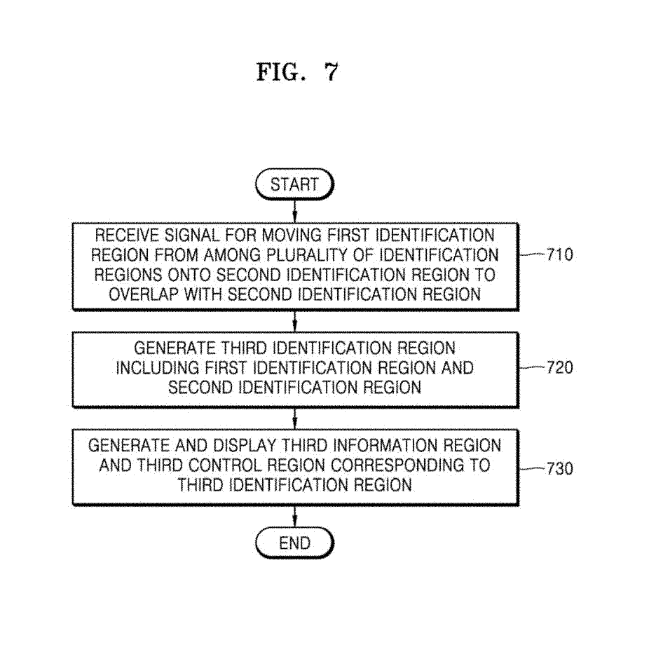

FIG. 7 is a flowchart for describing that an electronic device according to an embodiment of the present disclosure controls a plurality of sound output devices simultaneously by moving a plurality of identification regions.

In operation 710, the electronic device 300 may receive a signal for moving the first identification region 611 onto the second identification region 612 to overlap with the second identification region 612, from among the plurality of identification regions. The signal may be generated in various ways. For example, the signal may be generated when the user touches the display 310 of the electronic device 300.

In detail, a user signal may be generated when the user touches and drags a portion of the display 310, on which the first identification region 611 is displayed, towards the second identification region 612. According to another embodiment, the user signal may be generated when the user clicks and drags the first identification region 611 towards the second identification region 612 by using a mouse.

Based on a signal for moving the first identification region 611 onto the second identification region 612 from among the plurality of identification regions, the electronic device 300 may combine a list of the sound source content of the first sound output device 110-1 corresponding to the first sound identification region 611 with a list of sound source content of the second sound output device 110-2 corresponding to the second identification region 612.

In operation 720, the electronic device 300 may generate a third identification region by combining the first identification region 611 and the second identification region 612. The third identification region may display an identification value of the first sound output device and an identification value of the second sound output device. The electronic device 300 may control the first sound output device corresponding to the first identification region 611 and the second sound output device corresponding to the second identification region 612 together, by using the third identification region.

In operation 730, the electronic device 300 may generate and display a third information region and a third control region corresponding to the third identification region. The electronic device 300 may display the third information region and the third control region together with the third identification region. The electronic device 300 may generate the third information region and the third control region based on the first information region 621 and the first control region 651, or may generate the third information region and the third control region based on the second information region 622 and the second control region 652. Alternatively, the electronic device 300 may generate the third information region and the third control region, irrelevant to the first information region 621 and the first control region 651 or the second information region 622 and the second control region 652.

When the plurality of identification regions 611 and 612 are combined with each other, the electronic device 300 may select a music source of the first sound output device 110-1 corresponding to the first identification region 611 and a music source of the second sound output device 110-2 corresponding to the second identification region 612. However, the present disclosure is not limited thereto, that is, the electronic device 300 may connect the first sound output device 110-1 and the second sound output device 110-2 to a new music source. Also, the source and list of the sound source content to be displayed in the third information region may be set by the electronic device 300 in advance based on a user input.

For example, when the first identification region 611 is moved onto the second identification region 612, the electronic device 300 may generate the third information region and the third control region according to the GUI configuration of the second information region 622 and the second control region 652. According to another embodiment, when the first identification region 611 is moved onto the second identification region 612, the electronic device 300 may generate the third information region and the third control region according to the GUI configuration of the first information region 621 and the first control region 651. However, the present disclosure is not limited thereto, that is, the electronic device 300 may generate and display the third information region and the third control region in various types.

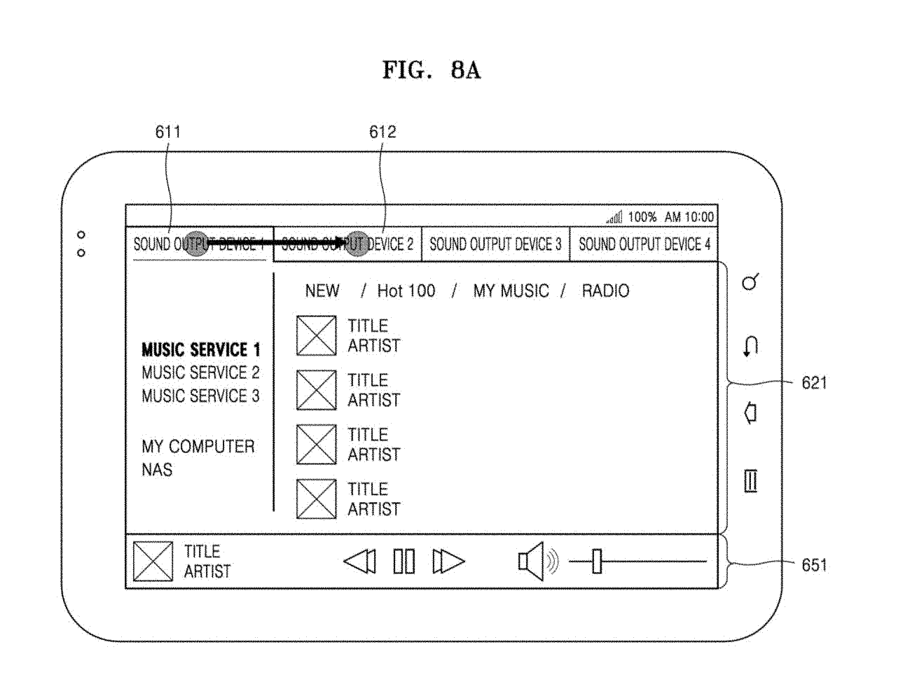

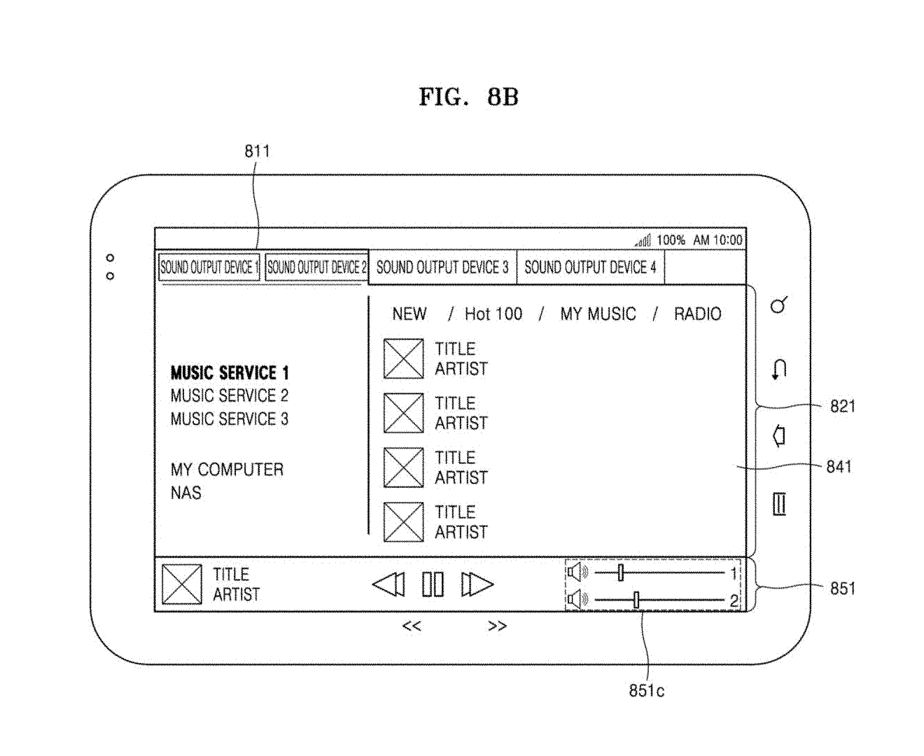

FIGS. 8A and 8B are diagrams of a screen for simultaneously controlling a plurality of sound output devices by moving a plurality of identification regions in an electronic device according to an embodiment of the present disclosure.

Referring to FIG. 8A, the electronic device 300 may receive a signal for moving the first identification region 611 onto the second identification region 612 to overlap with the second identification region 612, on the screen displaying information related to the first sound output device 110-1.

For example, the electronic device 300 may display the plurality of identification regions 611 and 612, and may display the first information region 621 and the first control region 651 to correspond to the first identification region 611 selected by the user. The electronic device 300 may represent the music source connected to the first sound output device 110-1 in a first information region A 631 and may represent sound source content on a first information region B 641. The electronic device 300 may represent an identification value of the sound source content that is currently playing and control icons in the first control region 651.

According to an embodiment, the electronic device 300 may receive a signal for moving the first identification region 611 to the second identification region 612. As described above, the signal may be generated in various ways, e.g., a touch input of the user, manipulating of the mouse, etc.

Referring to FIG. 8B, the electronic device 300 may display a third identification region 811 that is generated by combining the first identification region 611 and the second identification region 612 with each other. According to an embodiment, the electronic device 300 may express the first identification region 611 and the second identification region 612 to be discriminated from each other in the third identification region 811. As such, the user may easily separate the first identification region 611 and the second identification region 612 in the third identification region 811. For example, the user may separate the first and second identification regions 611 and 612 from each other by touching or clicking with a mouse a region of the display, in which the first identification region 611 or the second identification region 612 is located.

The electronic device 300 may display a third information region 821 to correspond to the third identification region 811.

According to an embodiment, the electronic device 300 may display the third information region 821 to be identical with the first information region 621. That is, as described above with reference to operation 730 of FIG. 7, the electronic device 300 may connect the first sound output device 110-1 and the second sound output device 110-2 to the music source connected to the first sound output device 110-1 corresponding to the first identification region 611.

In this case, when the second sound output device 110-2 has been connected to another music source, the electronic device 300 may disconnect the connection to stop outputting the sound source content, and then, may connect the second sound output device 110-2 to the music source of the first sound output device 110-1. Thus, the sound source output from the first sound output device 110-1 may be also output from the second sound output device 110-2.

According to various embodiments, when the first sound output device 110-1 and the second sound output device 110-2 are connected to different music sources from each other, the electronic device 300 may combine the list of the sound source content included in both music sources so that the sound source content connected to the first sound output device 110-1 may be reproduced and after that, the sound source content connected to the second sound output device 110-2 may be reproduced.

Alternatively, when the second sound output device 110-2 has been connected to the same music source as that of the first sound output device 110-1, the may combine the list of the sound source content of the second sound output device 110-2 with the list of the sound source content of the first sound output device 110-1.

The electronic device 300 may display a third control region 851 to correspond to the third identification region 811.

According to an embodiment, the electronic device 300 may display the third control region 851 to be identical with the first control region 651. That is, as described above with reference to operation 730 of FIG. 7, the electronic device 300 may connect the first sound output device 110-1 and the second sound output device 110-2 to the music source connected to the first sound output device 110-1 corresponding to the first identification region 611.

In this case, the electronic device 300 may represent a volume adjustment icon 851c to include a volume adjusting bar corresponding to the first sound output device 110-1 and a volume adjusting bar corresponding to the second sound output device 110-2. Even when two sound output devices 110 reproduce the same sound source, the user may adjust the volume of each of the sound output devices 110 according to peripheral environment.

According to another embodiment, the electronic device 300 may realize surround sound, stereophonic sound, etc. by using two sound output devices 110, and may set one of the two as a main sound output device and the other as a sub-sound output device based on output performance of the sound output devices.

As described above, the user may change the screen so as to control a plurality of sound output devices in one screen with only a simple operation of moving a region on the screen.

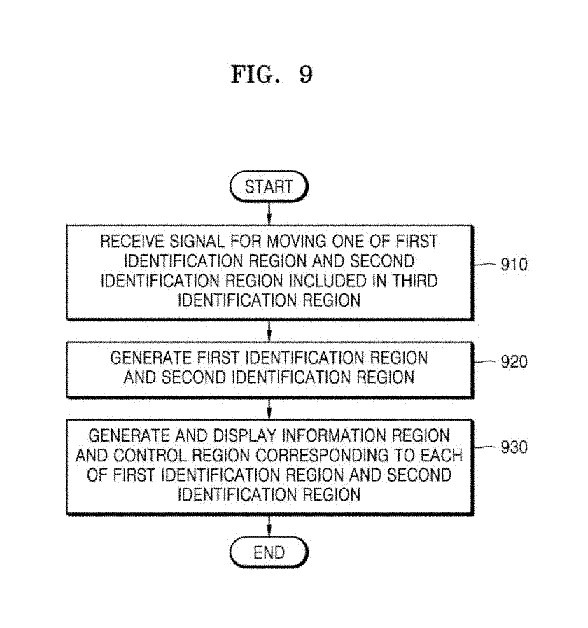

FIG. 9 is a flowchart for describing that an electronic device according to an embodiment of the present disclosure individually controls sound output devices by separately moving an identification region.

In operation 910, the electronic device 300 may receive a signal for moving one of the first identification region 611 and the second identification region 612 included in the third identification region 811.

The signal may be generated in various ways. For example, the user signal may be generated when the user touches and drags a region of the display 310, in which the first identification region 611 or the second identification region 612 is represented, to an outer portion of the third identification region 811. According to another embodiment, the user signal may be generated when the user clicks and drags the first identification region 611 or the second identification region 612 by using a mouse to an outer portion of the third identification region 811.

Based on the signal for moving one of the plurality of identification regions to the outer portion of the third identification region 811, the electronic device 300 may separate the sound source content included in the first sound output device 110-1 corresponding to the first identification region 611 from the sound source content included in the second sound output device 110-2 corresponding to the second identification region 612.

In operation 920, the electronic device 300 may delete the third identification region 811, and generate the first identification region 611 and the second identification region 612. The electronic device 300 may separate the first identification region 611 and the second identification region 612 from the third identification region 811, and may respectively represent the first identification region 611 and the second identification region 612 separately. The electronic device 300 may separately control the first sound output device 110-1 corresponding to the first identification region 611 and the second sound output device 110-2 corresponding to the second identification region 612.

In operation 930, the electronic device 300 may generate and display the first information region 621 and the first control region 651 corresponding to the first identification region 611, or the second information region 622 and the second control region 652 corresponding to the second identification region 612.

The electronic device 300 may display the first information region 621 and the first control region 651, or the second information region 622 and the second control region 652, together with the first identification region 611 or the second identification region 612.

For example, when the first identification region 611 moves to the outer portion of the third identification region 811, the electronic device 300 may generate the second identification region 612, the second information region 622, and the second control region 652 as the GUI configuration before the combination. According to another embodiment, when the first identification region 611 is moved to the outer portion of the third identification region 811, the electronic device 300 may generate the first identification region 611, the first information region 621, and the first control region 651 according to the GUI configuration before the combination.

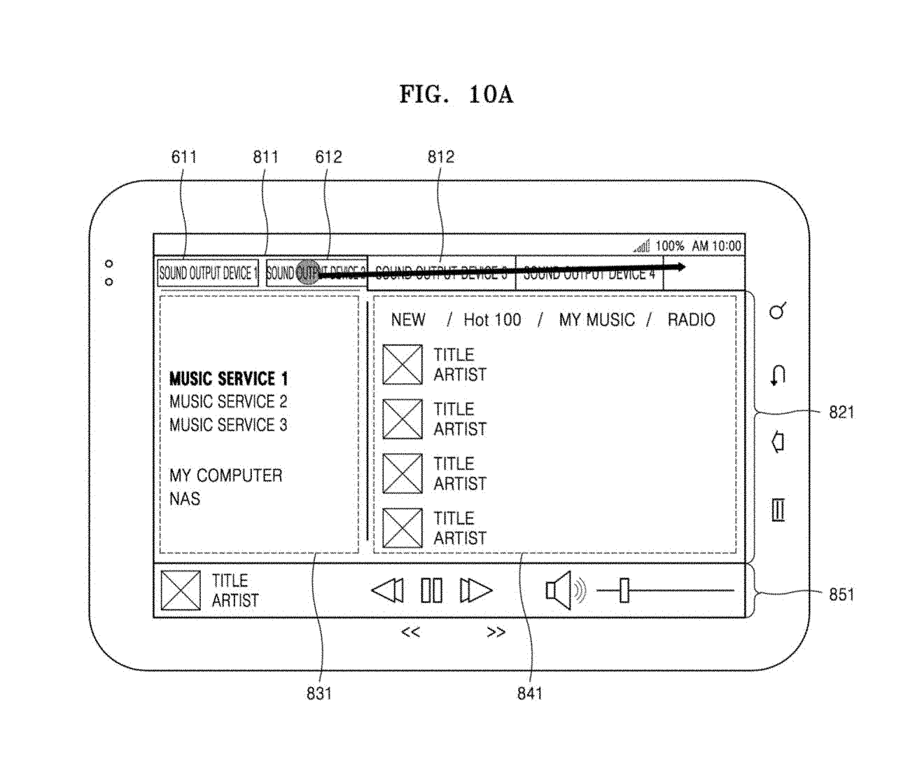

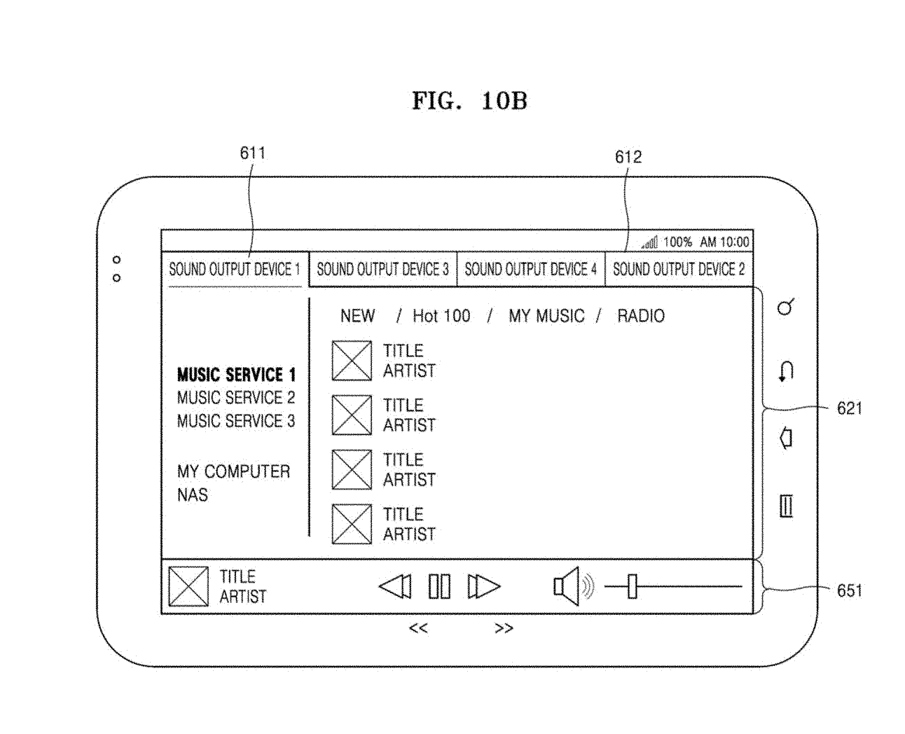

FIGS. 10A and 10B are diagrams of a screen for individually controlling sound output devices by separating and moving an identification region in an electronic device according to an embodiment of the present disclosure.

Referring to FIG. 10A, the electronic device 300 may receive a signal for moving the second identification region 612 to the outer portion of the third identification region 811 in a screen on which information regarding the first sound output device 110-1 and the second sound output device 110-2.

In detail, the electronic device 300 may display a plurality of identification regions 811 and 812, and may display a third information region (821) and a third control region 851 to correspond to the third identification region 811 selected by the user. The electronic device 300 may display music sources connected to the first sound output device 110-1 and the second sound output device 110-2 in a third information region A 831, and may display sound source content in a third information region B 841. The electronic device 300 may represent sound source content that is currently playing and control icons in the third control region 851.

According to an embodiment, the electronic device 300 may receive a signal for moving the second identification region 612 to the outer portion of the third identification region 811. As described above, the signal may be generated in various ways, e.g., a touch input of the user, manipulation of the mouse, etc.

Referring to FIG. 10B, the electronic device 300 may delete the third identification region 811, and may display the first identification region 611. However, one or more embodiments are not limited thereto. For example, when the second identification region 612 is moved to an outer portion of the third identification region 811, the electronic device 300 may display the second information region 622 and the second control region 652 corresponding to the second identification region 612. According to another embodiment, the user may set the sound output device in the electronic device 300 in advance.

The electronic device 300 may display the first information region 621 to correspond to the first identification region 611.

According to an embodiment, the electronic device 300 may display the first information region 621 to be identical with the third information region 821. That is, the electronic device 300 may allow the first sound output device 110-1 to maintain the connection to the music source. In this case, the electronic device 300 may disconnect the second sound output device 110-2 from the music source, and then connect the second sound output device 110-2 to the music source, to which the second sound output device 110-2 has been connected before being connected to the first sound output device 110-1.

According to another embodiment, if the first sound output device 110-1 is connected to the identical music source with that of the second sound output device 110-2 before the electronic device 300 controls the two sound output devices integrally, the electronic device 300 may separate the sound source content included in the first sound output device 110-1 from the sound source content included in the second sound output device 110-2.

The electronic device 300 may display the first control region 651 to correspond to the first identification region 611.

As described above, when the electronic device 300 continuously connects the first sound output device 110-1 to the music source that has been previously connected to the first sound output device 110-1, the electronic device 300 may display the first control region 651 to be identical with the third control region 851.

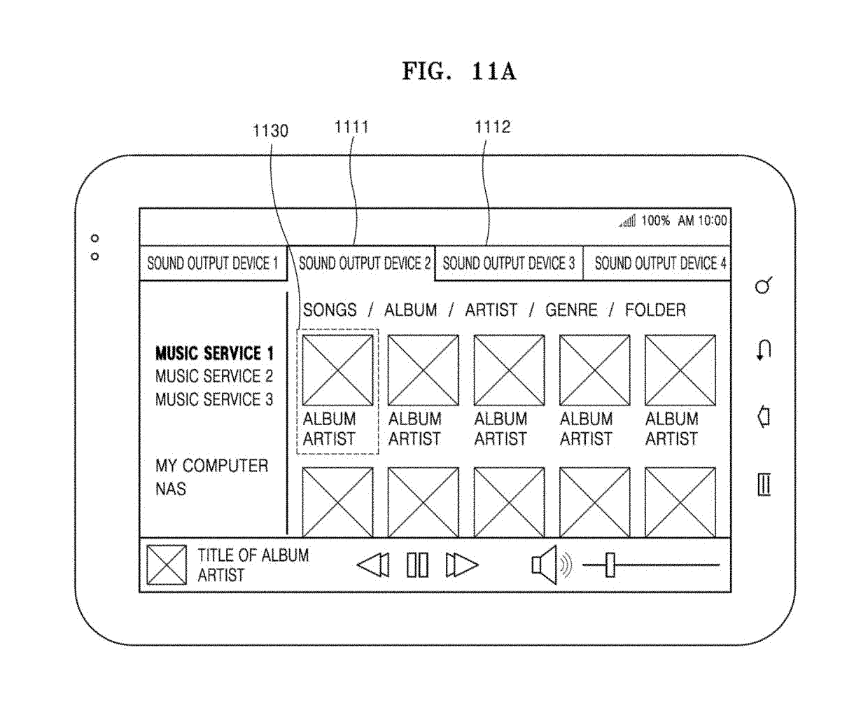

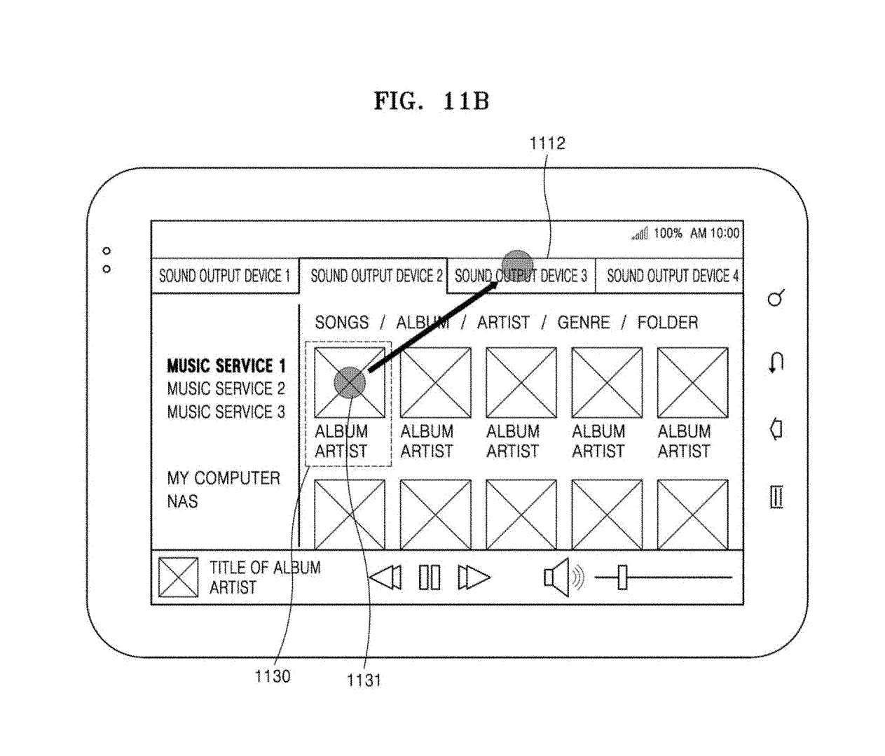

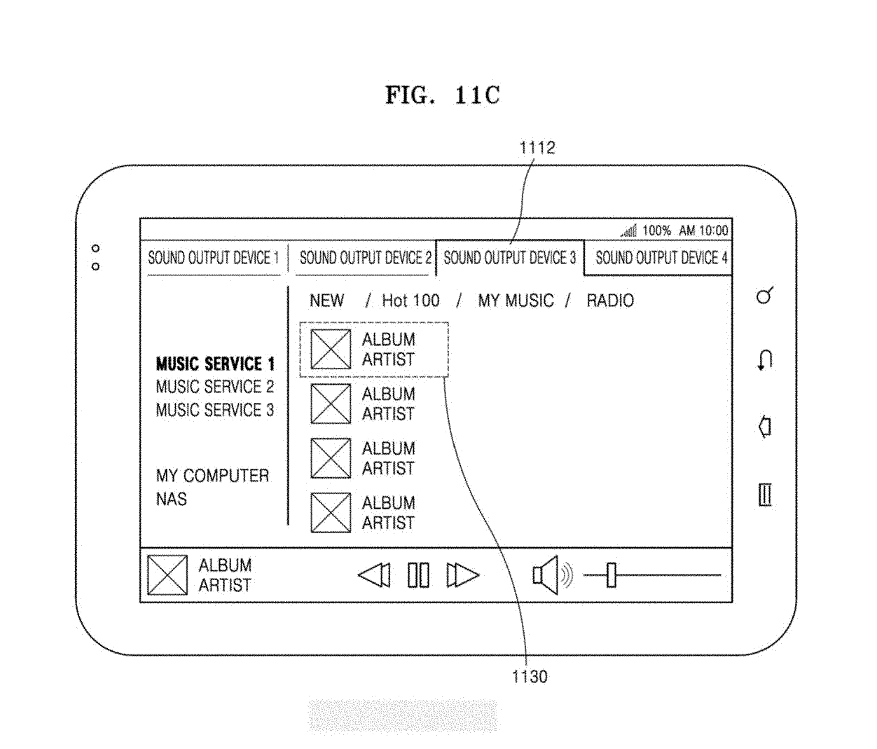

FIGS. 11A to 110 are diagrams showing a situation in which sound source content is moved in an electronic device according to an embodiment of the present disclosure.

FIG. 11A shows a GUI screen for controlling the sound output devices 110. The GUI configuration is described in detail above with reference to FIG. 6, and thus, descriptions thereof are omitted.

Referring to FIG. 11, the electronic device 300 may make the sound source content corresponding to one sound output device output from another sound output device.

Referring to FIG. 11A, based on a user input for moving sound source content 1130 displayed in a second information region 1120 to a third identification region 1112, the electronic device 300 may transfer data of the sound source content 1130 to a sound output device corresponding to the third identification region 1112.

Referring to FIG. 11B, the user may move the sound source content 1130 displayed on the display 310. For example, when the electronic device 300 is a personal computer (PC), the user may move the sound source content 1130 displayed as an icon by performing a drag and drop operation with a mouse. According to one or more embodiments, when the electronic device 300 is a tablet PC, the user may move the sound source content 1130 by touching and dragging on a portion 1131 at which the sound source content 1130 is displayed.

Referring to FIG. 11C, the electronic device 300 may display the sound source content 1130 that has been moved in a list of sound source content corresponding to the third identification region 1112. As described above with reference to FIG. 4A, when the user moves the icon representing the sound source content in the electronic device, the electronic device 300 may change the music source connected to the sound output device or may move and/or copy the sound source content stored in the sound output device.

According to one or more embodiments, the electronic device 300 may move the sound source content 1130 itself, or may maintain the sound source content 1130 and move a copy of the sound source content 1130. For example, an icon representing a certain sound source may be deleted from the second information region corresponding to the second identification region, and may be displayed on the third information region corresponding to the third identification region. Alternatively, for example, an icon representing a certain sound source may be displayed on the second information region corresponding to the second identification region, and may be also displayed on the third information region corresponding to the third identification region.

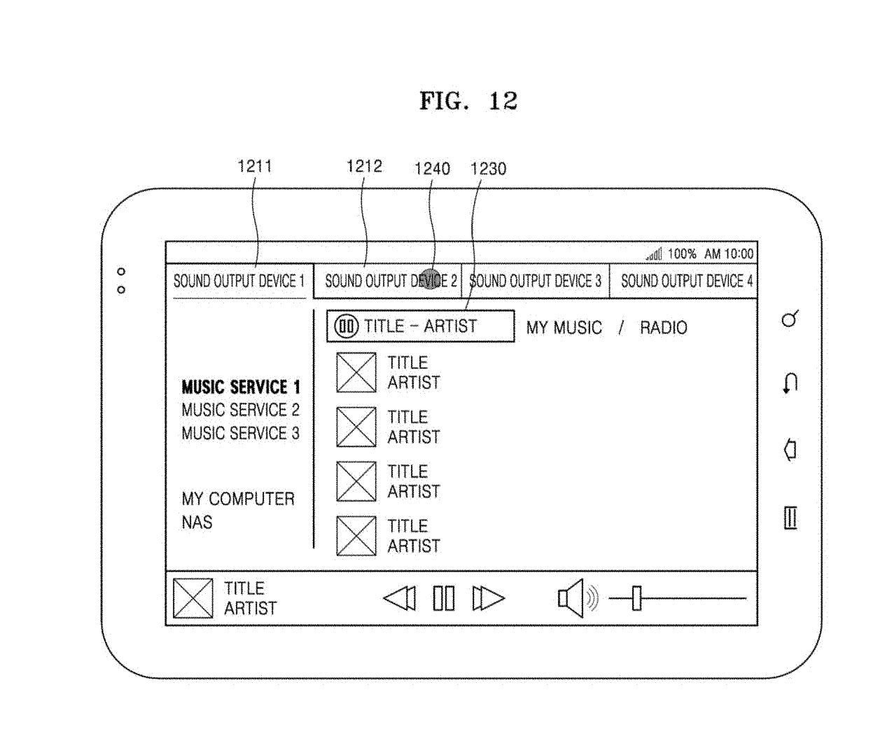

FIG. 12 is a diagram showing an electronic device displaying sound source content, according to an embodiment of the present disclosure.

FIG. 12 shows a GUI screen for controlling the sound output devices 110. The GUI configuration is described in detail above with reference to FIG. 6, and thus, descriptions thereof are omitted.

Referring to FIG. 12, the electronic device 300 may display sound source content corresponding to one sound output device as a pop-up. While the electronic device 300 displays a first identification region 1211, a first identification region (1211), and a first information region 1251 corresponding to the first sound output device 110-1, the user may places a selection icon (e.g., a cursor of a mouse) on the second identification region 1212 or may hover over the second identification region 1212 by using a pen or a hand (1240).

In this case, the electronic device 300 may display sound source content 1230 as a pop-up, wherein the sound source content 1230 is being reproduced or is ready to be reproduced by a sound output device corresponding to the second identification region 1212. As such, the user may identify the sound source content of the sound output device corresponding to the second identification region 1212 without selecting the second identification region 1212.

According to an embodiment, the user may move the pop-up sound source content 1230 to an arbitrary identification region to move the sound source content 1230.

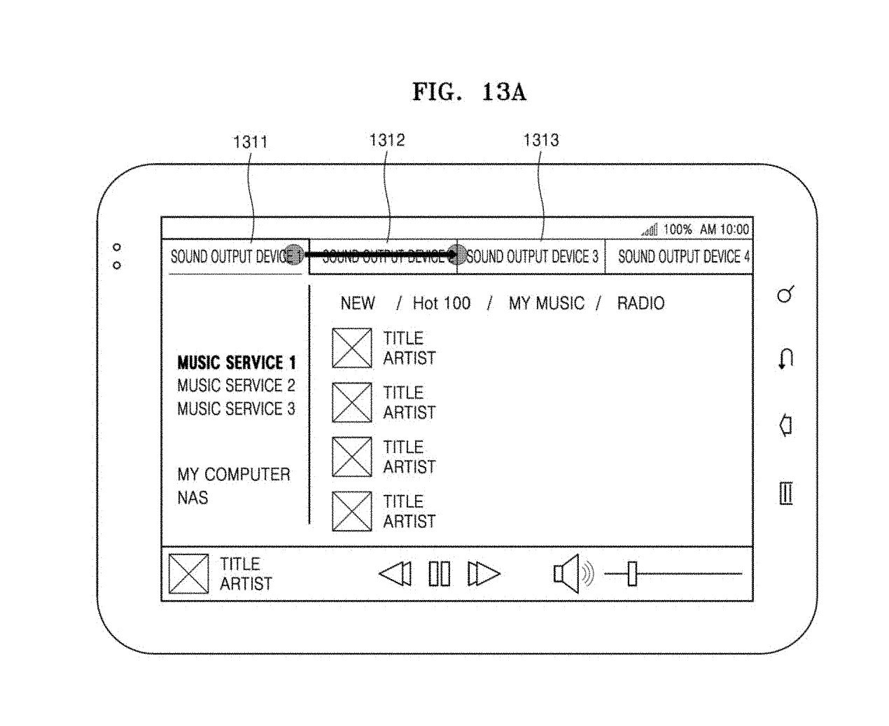

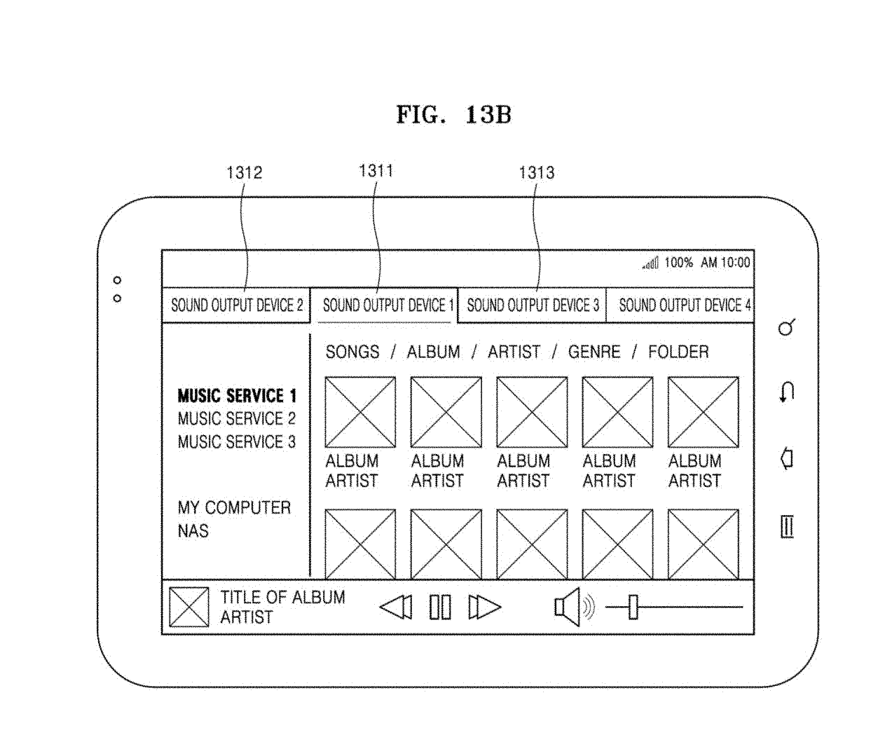

FIGS. 13A and 13B are diagrams showing an electronic device switching an order of identification regions, according to an embodiment of the present disclosure.

FIG. 13 shows a GUI screen for controlling the sound output devices 110. The GUI configuration is described in detail above with reference to FIG. 6, and thus, descriptions thereof are omitted.

Referring to FIG. 13, the electronic device 300 may move the identification regions. Referring to FIGS. 13A and 13B, the user may long touch a first identification region 1311, and then, may move the first identification region 1311 between a second identification region 1312 and a third identification region 1313. However, the present disclosure is not limited thereto, that is, the user may move the first identification region 1311 by clicking and dragging with a mouse, or may move the first identification region 1311 by using other physical buttons, etc.

Although not shown in the drawings, the electronic device 300 may express identification regions as one icon, wherein the identification regions are connected to the network 130 but may not be displayed due to a limitation in a size of the display 310. When the user selects the icon, the identification regions may be displayed as a pop-up. Here, the user may select one of the identification regions and may move the selected identification region to be displayed on the screen. On the contrary, the user may move the identification region displayed on the screen to the above icon to hide the identification region.

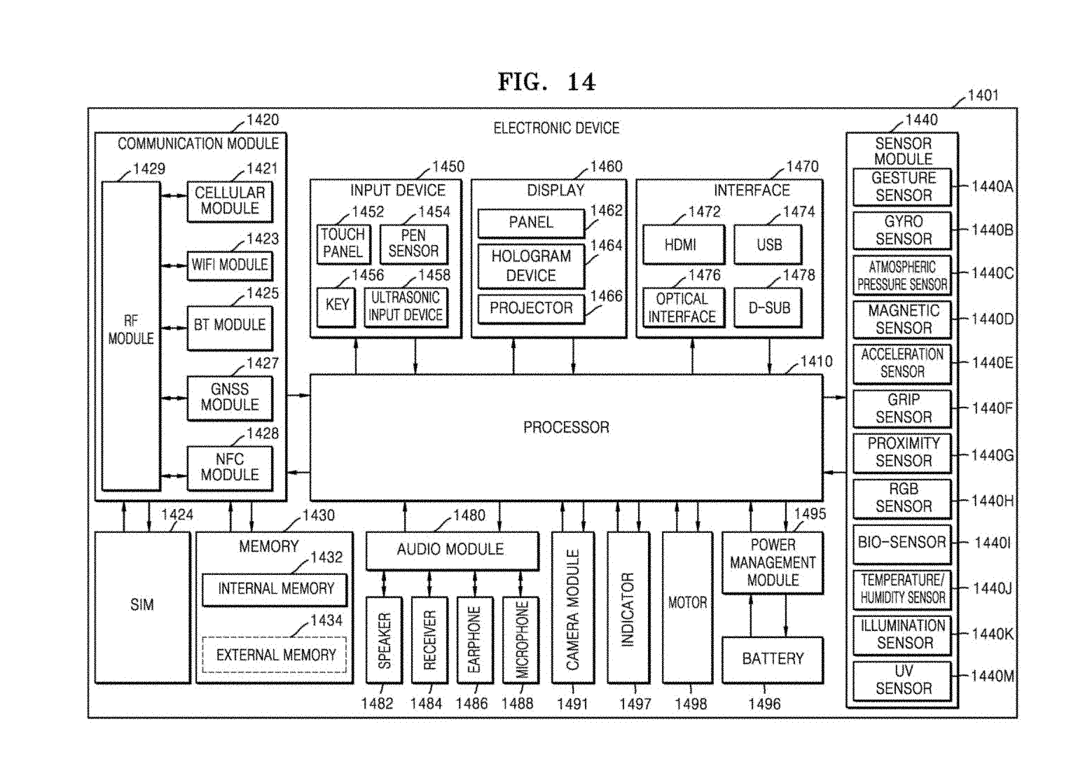

FIG. 14 is a block diagram of an electronic device 1401 according to various embodiments. The electronic device 100 of FIG. 1 may include the electronic device 1401. The electronic device 1401 may include, for example, whole or some parts of the electronic device 100 illustrated in FIG. 1. The electronic device 1401 may include one or more application processors (e.g. AP) 1410, a communication module 1420, a subscriber identification module 1424, a memory 1430, a sensor module 1440, an input device 1450, a display 1460, an interface 1470, an audio module 1480, a camera module 1491, a power management module 1495, a battery 1496, an indicator 1497, and a motor 1498.

The application processor 1410 may drive, for example, an operating system or an application program to control a plurality of hardware or software components connected to the application processor 1410, and may perform various data processing and calculation. The processor 320 of FIG. 3 may include the application processor 1410 of FIG. 14. The application processor 1410 may be implemented as, for example, a system on chip (SOC). According to one example embodiment, the application processor 1410 may further include a graphic processing unit (GPU) and/or an image signal processor. The application processor 1410 may include at least some (e.g., a cellular module 1421) of the components illustrated in FIG. 14. The application processor 1410 may load the command or data transmitted from at least one of the other components (e.g., non-volatile memory) on a volatile memory to process the command or data, and may store various data in the non-volatile memory.

The communication module 1420 may have a structure that is the same as or similar to that of the communication interface 270 of FIG. 2. The communication module 1420 may include, for example, the cellular module 1421, a WiFi module 1423, a Bluetooth module 1425, a GNSS module 1427 (e.g., a GPS module, a Glonass module, a Beidou module, or a Galileo module), an NFC module 1428, and a radio frequency (RF) module 1429.

The cellular module 1421 may provide, for example, voice call service, video call service, text message service, or Internet service via a communication network.

Each of the WiFi module 1423, the Bluetooth module 1425, the GNSS module 1427, and the NFC module 1428 may include a processor for processing data transmitted/received through the corresponding module.

The RF module 1429 may transmit/receive, for example, a communication signal (e.g., an RF signal). The RF module 1429 may include, for example, a transceiver, a power amp module (PAM), a frequency filter, a low noise amplifier (LNA), or an antenna. According to another example embodiment, at least one of the cellular module 1421, the WiFi module 1423, the Bluetooth module 1425, the GNSS module 1427, and the NFC module 1428 may transmit/receive an RF signal via an additional RF module.

The subscriber identification module 1424 may include, for example, a card including the subscriber identification module and/or an embedded SIM, and may include unique identification information (e.g., integrated circuit card identifier (ICCID)) or subscriber information (e.g., international mobile subscriber identity (IMSI)).

The memory 1430 may include, for example, an internal memory 1432 or an external memory 1434. The internal memory 1432 may include, for example, at least one of a volatile memory (e.g., dynamic RAM (DRAM), static RAM (SRAM), synchronous dynamic RAM (SDRAM), etc.), a non-volatile memory (e.g., one time programmable ROM (OTPROM), programmable ROM (PROM), an erasable and programmable ROM (EPROM), an electrically erasable and programmable ROM (EEPROM), a mask ROM, a flash ROM, a flash memory (e.g., NAND flash, NOR flash, etc.), hard drive, or solid state drive (SSD).

The external memory 1434 may further include a flash drive, for example, a compact flash (CF), secure digital (SD), micro-SD, Mini-SD, extreme digital (xD), a multi-media card (MMD), a memory stick, etc. The external memory 1434 may be functionally and/or physically connected to the electronic device 1401 via various interfaces.

The sensor module 1440 may measure a physical amount or sense an operating state of the electronic device 1401, so as to convert measured or sensed information into an electric signal. The sensor module 1440 may include, for example, at least one of a gesture sensor 1440A, a gyro sensor 1440B, an atmospheric pressure sensor 1440C, a magnetic sensor 1440D, an acceleration sensor 1440E, a grip sensor 1440F, a proximity sensor 1440G, a color sensor 1440H (e.g., a red, green, blue (RGB) sensor), a bio sensor 1440I, a temperature/humidity sensor 1440J, an illuminance sensor 1440K, and an ultra violet (UV) sensor 1440M. Additionally or alternatively, the sensor module 1440 may include, for example, an E-nose sensor, an electromyography (EMG) sensor, an electroencephalogram (EEG) sensor, an electrocardiogram (ECG) sensor, an infrared (IR) sensor, an iris sensor, and/or a fingerprint sensor. The sensor module 1440 may include a control circuit for controlling at least one sensor included therein. In some embodiments, the electronic device 1401 may further include a processor configured to control the sensor module 1440, as a part of the application processor 1410 or separately, and thus, the sensor module 1440 may be controlled while the application processor 1410 is in a sleep mode.

The input device 1450 may include, for example, a touch panel 1452, a (digital) pen sensor 1454, a key 1456, or an ultrasonic input device 1458.

The display 1460 (e.g., the display 260) may include a panel 1462, a hologram device 1464, or a projector 1466. The panel 1462 may have a structure that is the same as or similar to that of the display 260 shown in FIG. 2. The panel 1462 may be configured to be, for example, flexible, transparent, or wearable. The panel 1462 may be configured as one module with the touch panel 1452. The hologram device 1464 may show a stereoscopic image in the air by using interference of light. According to one example embodiment, the display 1460 may further include a control circuit for controlling the panel 1462, the hologram device 1464, or the projector 1466.

The interface 1470 may include, for example, a high-definition multimedia interface (HDMI) 1472, a universal serial bus (USB) 1474, an optical interface 1476, or a D-subminiature (D-sub) 1478.

The audio module 1480 may bi-directionally convert sound and electric signals to each other. At least some of components of the audio module 1480 may be included in, for example, the input/output interface 250 shown in FIG. 2. The audio module 1480 may process sound information input or output through, for example, a speaker 1482, a receiver 1484, earphones 1486, or a microphone 1488.

The camera module 1491 is, for example, a device capable of capturing still images and videos, and according to an example embodiment, the camera module 225 may include one or more imaging sensors (e.g., a front sensor or a rear sensor), a lens, an image signal processor (ISP), or a flash (e.g., a light emitting diode (LED), a xenon lamp, etc.)

The power management module 1495 may manage power of the electronic device 1401. According to one example embodiment, the power management module 1495 may include a power management integrated circuit (PMIC), a charger IC, or a battery or fuel gauge. The PMIC may be charged through wires and/or wirelessly. The wireless charging method may include, for example, a magnetic resonance method, a magnetic induction method, or an electromagnetic wave method, and an additional circuit for wireless charging, for example, a coil loop, a resonant circuit, or a rectifier may be further provided. The indicator 1497 may display a certain state of the electronic device 1401 or a part of the electronic device 1401 (e.g., the application processor 1410), for example, a booting state, a message state, or a charging state. The motor 1498 may convert an electric signal into mechanical vibration, and may generate vibration effect or haptic effect. Although not shown in the drawing, the electronic device 1401 may include a processing device (e.g., GPU) for supporting mobile TV function.

Each of the aforementioned components of the electronic device may include one or more parts, and a name of the part may vary with a type of the electronic device. The electronic device in accordance with various exemplary embodiments may include at least one of the aforementioned components, omit some of them, or include other additional components. Some of the components may be combined into an entity, but the entity may perform the same functions as the components may do.

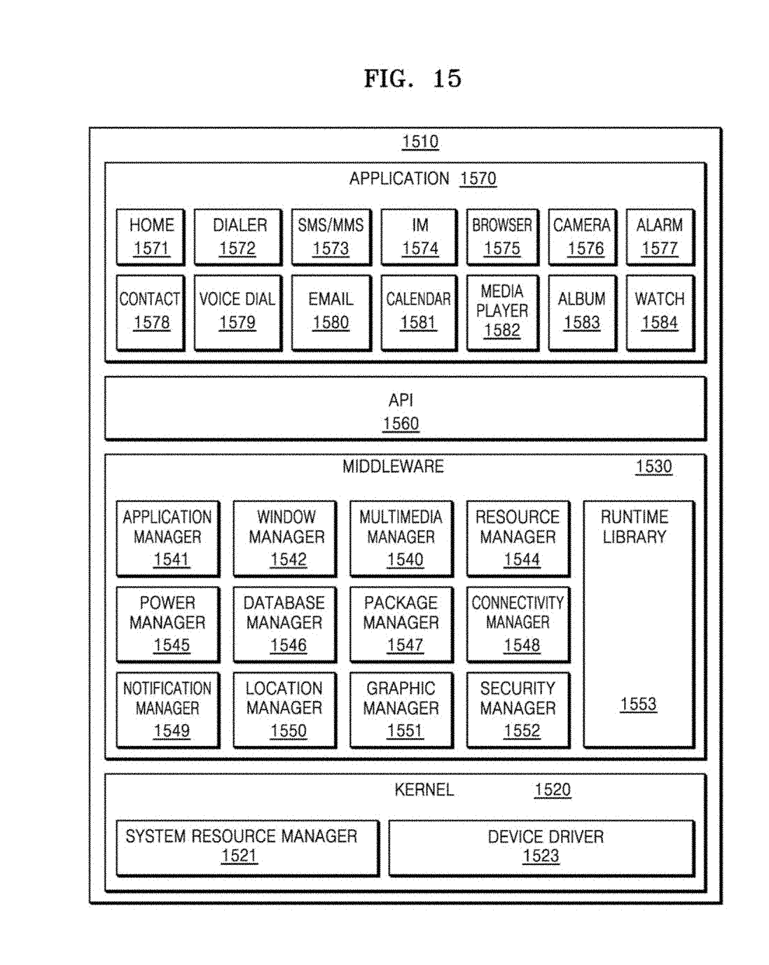

FIG. 15 is a block diagram of a program module according to various embodiments. According to an embodiment, a programming module 1510 (e.g., a program 240) may include an operating system (OS) controlling resources related to an electronic device (e.g., the electronic device 201) and/or various applications (e.g., an application program 247) executed in the OS. For example, the OS may be Android, iOS, Windows, Symbian, Tizen, Bada, and the like.

The programming module 1510 may include a kernel 1520, a middleware 1530, an application programming interface (API) 1560, and/or an application 1570. At least a part of the programming module 1510 may be preloaded on an electronic device or may be downloaded from an external electronic device (e.g., electronic devices 102 and 104, a server 106, etc.)

The kernel 1520 (e.g., the kernel 241) may include, for example, a system resource manager 1521 or a device driver 1523. The system resource manager 1521 may perform control, allocation, retrieval, etc. of system resources. According to an embodiment, the system resource manager 1521 may include a process manager, a memory manager, a file system manager, or the like. The device driver 1523 may include, for example, a display driver, a camera driver, a Bluetooth driver, a shared memory driver, a USB driver, a keypad driver, a WiFi driver, an audio driver, or an inter-process communication (IPC) driver.

The middleware 1530 may provide functions that the application 1570 commonly requires or provide various functions to the application 1570 through the API 1560 to allow the application 1570 to efficiently use a limited system resource in the electronic device. According to an embodiment, the middleware 1530 (e.g., the middleware 243) may include at least one of a runtime library 1535, an application manager 1541, a window manager 1542, a multimedia manager 1543, a resource manager 1544, a power manager 1545, a database manager 1546, a package manager 1547, a connectivity manager 1548, a notification manager 1549, a location manager 1550, a graphic manager 1551, and a security manager 1552.

The middleware 1530 may include a middleware module forming a combination of various functions of the above-mentioned elements. The middleware 1530 may provide modules specified according to types of an OS so as to provide distinctive functions. In addition, the middleware 1530 may delete some of existing elements or add new elements dynamically.

The API 1560 (e.g., the API 245), which is a set of API programming functions, may be provided with a different configuration according to the OS. For example, in the case of Android or iOS, one API set may be provided for each platform, and in the case of Tizen, two or more API sets may be provided for each platform.

The application 1570 (e.g., the application program 247) may include one or more applications capable of providing a function, for example, a home application 1571, a dialer application 1572, a short messaging service/multimedia messaging service (SMS/MMS) application 1573, an instant message (IM) application 1574, a browser application 1575, a camera application 1576, an alarm application 1577, a contact application 1578, a voice dial application 1579, an e-mail application 1580, a calendar application 1581, a media player application 1582, an album application 1583, a clock application 1584, a health care application (e.g., an application for measuring an exercise amount, a blood sugar, etc.), or an environment information providing application (e.g., an application for providing air pressure, humidity, temperature information, etc.).

According to an embodiment, the application 1570 may include an application (hereinafter, an “information exchange application” for convenience of description) supporting information exchange between the electronic device (e.g., the electronic device 101) and an external electronic device (e.g., the electronic device 202 or 204). The information exchange application may include, for example, a notification relay application for transferring specific information to the external electronic device or a device management application for managing the external electronic device.

According to an embodiment, the application 1570 may include an application set on the basis of an attribute (e.g., a health care application of a mobile medical appliance) of the external electronic device (e.g., the electronic device 202 or 204). According to an embodiment, the application 1570 may include an application received from the external electronic device (e.g., the server 206 or the electronic device 202 or 204). According to an embodiment, the application 1570 may include a preloaded application or a third party application that may be downloaded from the server. Names of elements of the programming module 1510 according to the illustrated embodiment may vary depending on a type of an OS.

According to various embodiments, at least a part of the programming module 1510 may be implemented by software, firmware, hardware, or a combination of at least two of them. The at least a part of the programming module 1510 may be implemented (e.g., executed) by a processor (e.g., the application processor 1410). At least a part of the programming module 1510 may include, for example, modules, programs, routines, sets of instructions, or processes for performing one or more functions.

The term “module” used herein may refer to a unit including one of hardware, software, and firmware, or a combination thereof. The term “module” may be interchangeably used with a unit, logic, logical block, component, or circuit. The “module” may be a minimum unit or part of an integrated component. The “module” may be a minimum unit or part of performing one or more functions. The “module” may be implemented mechanically or electronically. For example, the “module” may include at least one of application specific integrated circuit (ASIC) chips, field programmable gate arrays (FPGAs), or programmable logic arrays (PLAs) that perform some operations, which have already been known or will be developed in the future.

According to an exemplary embodiment, at least a part of the device (e.g., modules or their functions) or method (e.g., operations) may be implemented as instructions stored in a computer-readable storage medium e.g., in the form of a program module. The instructions, when executed by a processor (e.g., the processor 220), may enable the processor to carry out a corresponding function. The computer-readable storage medium may be, e.g., the memory 230.

The computer-readable storage medium may include a hardware device, such as hard discs, floppy discs, and magnetic tapes (e.g., a magnetic tape), optical media such as compact disc read only memories (ROMs) (CD-ROMs) and digital versatile discs (DVDs), magneto-optical media such as floptical disks, ROMs, random access memories (RAMs), flash memories, or the like. Examples of the program instructions may include not only machine language codes but also high-level language codes which are executable by various computing means by using an interpreter. The aforementioned hardware devices may be configured to operate as one or more software modules to carry out exemplary embodiments, and vice versa.

A non-transitory recording medium having stored thereon a method of controlling an electronic device that controls a plurality of sound output devices according to an embodiment may store searching for the plurality of sound output devices connected to a network, displaying a plurality of identification regions representing the plurality of sound output devices that are found, and an information region representing information regarding a sound output device corresponding to at least one of the plurality of identification regions, and setting the plurality of sound output devices to operate with one another based on a signal for moving at least one of the plurality of identification regions.

Modules or programming modules in accordance with various exemplary embodiments may include at least one or more of the aforementioned components, omit some of them, or further include other additional components. Operations performed by modules, programming modules or other components in accordance with various embodiments may be carried out sequentially, simultaneously, repeatedly, or heuristically. Furthermore, some of the operations may be performed in a different order, or omitted, or include other additional operation(s). The embodiments disclosed in the present disclosure have been provided to easily describe the present disclosure and to help understanding of the present disclosure, and are not intended to limit the scope of the present disclosure. Therefore, the scope of this document should be construed to include all the changes, or various other embodiments based on the technical concept of the present disclosure.

1. An electronic device comprising:
a communication interface configured to communicate with a plurality of sound output devices;
a display; and
a processor electrically connected to the communication interface and the display,
wherein the processor is configured to search for the plurality of sound output devices by using the communication interface, to display on the display a plurality of identification regions representing the plurality of sound output devices, and an information region representing information about a sound output device corresponding to at least one of the plurality of identification regions, and to set the plurality of sound output devices to operate with one another based on a signal for moving at least one of the plurality of identification regions.

2. The electronic device of claim 1, wherein the information region displays at least one of a list of content to be output through the sound output device, an external electronic device connected to the sound output device, and information about a content providing service.

3. The electronic device of claim 1, wherein the processor is further configured to, based on a signal for moving a first identification region from among the plurality of identification regions to overlap with a second identification region, group the first identification region and the second identification region as a third identification region, and to control a sound output device corresponding to the first identification region and a sound output device corresponding to the second identification region together.

4. The electronic device of claim 3, wherein the processor is further configured to, when the first identification region is moved to overlap with the second identification region from among the plurality of identification regions, set content included in a first information region corresponding to the first identification region and content included in a second information region corresponding to the second identification region to be included in a third information region corresponding to the third identification region.

5. The electronic device of claim 3, wherein the processor is further configured to, when the first identification region is moved to overlap with the second identification region from among the plurality of identification regions, set sound source content output from a sound output device corresponding to the second identification region to be also output from a sound output device corresponding to the first identification region.

6. The electronic device of claim 3, wherein the processor is further configured to, when the first identification region is moved to overlap with the second identification region from among the plurality of identification regions, stop outputting of the sound source content from the sound output device corresponding to the first identification region, and set sound source content output from a sound output device corresponding to the second identification region to be also output from the sound output device corresponding to the first identification region.

7. The electronic device of claim 3, wherein the processor is further configured to, based on a signal for separating the first identification region and the second identification region from the third identification region, ungroup the first identification region and the second identification region and individually control a sound output device corresponding to the first identification region and a sound output device corresponding to the second identification region.

8. The electronic device of claim 7, wherein the processor is further configured to, when the first identification region and the second identification region are ungrouped, display content included in a third information region corresponding to the third identification region, respectively in a first information region corresponding to the first identification region and a second information region corresponding to the second identification region.

9. The electronic device of claim 7, wherein the processor is further configured to, when the first identification region and the second identification region are ungrouped, maintain outputting of sound source content from a sound output device corresponding to the first identification region and stop outputting sound source content from a sound output device corresponding to the second identification region.

10. The electronic device of claim 7, wherein the processor is further configured to, when the first identification region and the second identification region are ungrouped, stop outputting sound source content from a sound output device corresponding to the first identification region and display information about at least one of an external electronic device or a music service that has been connected to the sound output device before grouping on a first information region.

11. The electronic device of claim 2, wherein the processor is further configured to, based on a signal for moving at least one in a content list displayed in a first information region corresponding to the first identification region from among the plurality of identification regions to overlap with the second identification region, set content displayed on the first information region to be output from a sound output device corresponding to the second identification region.

12. The electronic device of claim 1, wherein the processor is further configured to, based on a signal for hovering over the second identification region or for locating a selection icon on the second identification region in a state where the first identification region from among the plurality of identification regions, a first information region, and a first control region are displayed, display a list of sound source content reproduced by a sound output device corresponding to the second identification region.

13. A sound output system comprising:
a plurality of sound output devices; and
an electronic device configured to search for the plurality of sound output devices by using a communication interface, to display on the display a plurality of identification regions representing the plurality of sound output devices, and an information region representing information about a sound output device corresponding to at least one of the plurality of identification regions, and to set the plurality of sound output devices to operate with one another based on a signal for moving at least one of the plurality of identification regions.

14. A method of controlling an electronic device that controls a plurality of sound output devices, the method comprising:
searching for the plurality of sound output devices connected to a network;
displaying a plurality of identification regions representing the plurality of sound output devices, and an information region representing information about a sound output device corresponding to at least one of the plurality of identification regions; and
setting the plurality of sound output devices to operate with one another based on a signal for moving at least one of the plurality of identification regions.

15. A computer-readable recording medium having recorded thereon a program for performing the method of claim 14 on a computer.
